(19) United States
(12) Patent Application Publication
(10) Pub. No.: US 2012/0005070 A1
(43) Pub. Date: Jan. 5, 2012

(54) SALES LEAD GENERATION SYSTEM USING A CREDIT SCORE SURVEY

(75) Inventors: Michael McFALL, Parkland, FL (US); Arthur DeLaurier, Parkland, FL (US); Dianne DeLaurier, Parkland, FL (US); Thomas Cross, Duluth, GA (US); Lou Loquasto, Roswell, GA (US)

(73) Assignee: Veretech Holdings, Inc., New York, NY (US)

(21) Appl. No.: 12/828,413

(22) Filed: Jul. 1, 2010

(51) Int. Cl. G06Q 40/00

(52) U.S. Cl. 705/38

(57) ABSTRACT

The invention is directed to a system for and a method of generating sales leads as a service for one or more vehicle dealerships that are not otherwise affiliated with the service. The invention may include maintaining a web site independently of the one or more vehicle dealerships that is accessible over a computer network by a consumer who is considering purchasing a vehicle, offering to the consumer while the consumer is accessing the web site to provide the consumer with an estimated credit score, wherein the consumer provides the consumer's contact information before the estimated credit score is provided, outputting a credit score survey to the consumer over the computer network, receiving one or more answers to the credit score survey from the consumer over the computer network, receiving information indicative of the vehicle transmitted from the consumer over the computer network, the information indicative of the vehicle comprising one or more selected from the group consisting of year, make, model, style, and color of the vehicle, receiving contact information of the consumer transmitted from the consumer over the computer network, determining, independently of the one or more vehicle dealerships, the estimated credit score by applying at least one scoring algorithm to the one or more answers to the credit score survey, providing the estimated credit score over the computer network to the consumer, and transmitting the contact information of the consumer, the estimated credit score, and the information indicative of the vehicle to the one or more vehicle dealerships as a sales lead.

### CROSS-REFERENCE TO RELATED APPLICATIONS

This application is related to U.S. patent application Ser. No. 10/640,852, filed on Aug. 14, 2003, now U.S. Pat. No. 7,050,982, which is herein incorporated by reference in its entirety.

### FIELD OF THE INVENTION

The invention relates to a system for generating leads (e.g., for the sale of vehicles, for the sale of real property). The invention relates to a system for generating leads by determining an offer price for a vehicle using historical data, such as wholesale sales that occur at vehicle auctions and dealerships, and dealer selected buyer criteria. The invention also relates to an online system for generating leads by determining an offer price for a vehicle using this information. The invention further relates to a system for generating leads by determining an approximate credit score of a user based on the user's answers to a credit score survey.

### BACKGROUND

In general, a consumer desiring to make a purchase (e.g., purchase a vehicle, purchase real estate property) may spend a substantial amount of time searching for financing resources (e.g., a loan from a financial institution). In such instances, the consumer may fill-out several long credit applications associated with various financial institutions. Most of these credit applications, however, may request highly sensitive information from the consumer (e.g., a consumer's social security number) and may be associated with a cost.

### SUMMARY OF THE INVENTION

Embodiments of the invention may include a method of generating sales leads as a service for one or more vehicle dealerships that are not otherwise affiliated with the service. The method may include maintaining a web site independently of the one or more vehicle dealerships that is accessible over a computer network by a consumer who is considering purchasing a vehicle, offering to the consumer while the consumer is accessing the web site to provide the consumer with an estimated credit score, wherein the consumer provides the consumer's contact information before the estimated credit score is provided, outputting a credit score survey to the consumer over the computer network, receiving one or more answers to the credit score survey from the consumer over the computer network, receiving information indicative of the vehicle transmitted from the consumer over the computer network, the information indicative of the vehicle comprising one or more selected from the group consisting of year, make, model, style, and color of the vehicle, receiving contact information of the consumer transmitted from the consumer over the computer network, determining, independently of the one or more vehicle dealerships, the estimated credit score by applying at least one scoring algorithm to the one or more answers to the credit score survey, providing the estimated credit score over the computer network to the consumer, and transmitting the contact information of the consumer, the estimated credit score, and the information indicative of the vehicle to the one or more vehicle dealerships as a sales lead.

Embodiments of the invention may include a system of generating sales leads as a service for one or more vehicle dealerships that are not otherwise affiliated with the service. The system may include a computing apparatus configured to maintain a web site independently of the one or more vehicle dealerships that is accessible over a computer network by a consumer who may be considering potentially purchasing a vehicle, a computing apparatus configured to offer to the consumer while the consumer is accessing the web site to provide the consumer with an estimated credit score, wherein the consumer provides the consumer's contact information before the estimated credit score is provided, a computing apparatus configured to output a credit score survey to the consumer over the computer network, a computing apparatus configured to receive one or more answers to the credit score survey from the consumer over the computer network, a computing apparatus configured to receive information indicative of the vehicle transmitted from the consumer over the computer network, the information indicative of the vehicle comprising one or more selected from the group consisting of year, make, model, style, and color of the vehicle, a computing apparatus configured to receive contact information of the consumer transmitted from the consumer over the computer network, a computing apparatus configured to determine, independently of the one or more vehicle dealerships, the estimated credit score by applying at least one scoring algorithm to the one or more answers to the credit score survey, a computing apparatus configured to provide the estimated credit score over the computer network to the consumer, and a computing apparatus configured to transmit the contact information of the consumer, the estimated credit score, and the information indicative of the vehicle to the one or more vehicle dealerships as a sales lead.

Embodiments of the invention may include a method of generating sales leads as a service for one or more real estate companies that are not otherwise affiliated with the service. The method may include maintaining a web site independently of the one or more real estate companies that is accessible over a computer network by a consumer who is considering purchasing real estate property, offering to the consumer while the consumer is accessing the web site to provide the consumer with an estimated credit score, wherein the consumer provides the consumer's contact information before the estimated credit score is provided, outputting a credit score survey to the consumer over the computer network, receiving one or more answers to the credit score survey from the consumer over the computer network, receiving information indicative of the real estate property transmitted from the consumer over the computer network, the information indicative of the real estate property comprising one or more selected from the group consisting of address, price, and type of the real estate property, receiving contact information of the consumer transmitted from the consumer over the computer network, determining, independently of the one or more real estate companies, the estimated credit score by applying at least one scoring algorithm to the one or more answers to the credit score survey, providing the estimated credit score over the computer network to the consumer, and transmitting the contact information of the consumer, the estimated credit score, and the information indicative of the real estate property to the one or more real estate companies as a sales lead.

### BRIEF DESCRIPTION OF THE DRAWINGS

The foregoing and other aspects and advantages will be better understood from the following detailed description of the invention with reference to the drawings, in which:

FIG. 1 is a diagram of an embodiment of the invention used over the Internet;

FIG. 2 is an exemplary diagram of a super sales lead system in accordance with the system of the invention;

FIGS. 3(a)-(f), 4(a)-(g), and 5(a)-(e) are exemplary computer screen shots of embodiments of Web page forms for submitting vehicle identification and condition information in accordance with the system of the invention;

FIGS. 3(g), 4(h), and 5(f) are exemplary computer screen shots of embodiments of a Web page form for submitting seller identifying information in accordance with the system of the invention;

FIG. 3(h) is an exemplary computer screen shot of an embodiment of a Web page demand certificate in accordance with the system of the invention;

FIGS. 4(g) and 5(i) are exemplary computer screen shots of an embodiment of a Web page estimated value in accordance with the system of the invention;

FIGS. 4(h) and 5(j) are exemplary computer screen shots of an embodiment of an email-based appraisal report in accordance with the system of the invention;

FIGS. 5(g)-(h) are exemplary computer screen shots of status message Web pages in accordance with the system of the invention;

FIGS. 6(a)-(d) are exemplary computer screen shots of an embodiment of a credit score survey in accordance with the system of the invention;

FIGS. 7(a)-(c) are exemplary charts of an embodiment of a scoring algorithm in accordance with the system of the invention;

FIG. 8 is an exemplary computer screen shot of an email-based sales lead in accordance with the system of the invention; and

FIG. 9 is a flowchart for a method of generating a lead in accordance with the system of the invention.

### DETAILED DESCRIPTION OF THE INVENTION

The invention will be understood more fully from the detailed description given below and from the accompanying drawings of embodiments of the invention; which, however, should not be taken to limit the invention to a specific embodiment but are for explanation and understanding only.

The description below describes systems and networks that may include one or more blocks, some of which are explicitly shown in the figures. The blocks depicted in the figures may be understood to refer to any, or a combination, of computer executable computing software, firmware, and hardware. It is noted that the blocks are exemplary. The blocks may be combined, integrated, separated, or duplicated to support various applications. Also, a function described herein as being performed at a particular block may be performed at one or more other blocks or by one or more other devices instead of or in addition to the function performed at the particular block. Further, the blocks may be implemented across multiple devices or other components local or remote to one another. Additionally, the blocks may be moved from one device and added to another device, or may be included in multiple devices.

It is further noted that the software described herein may be tangibly embodied in one or more physical media, such as, but not limited to any, or a combination, of a compact disc (CD), a digital versatile disc (DVD), a floppy disk, a hard drive, read only memory (ROM), random access memory (RAM), and other physical media capable of storing software. Moreover, the figures illustrate various components (e.g., systems, networks) separately. The functions described as being performed at various components may be performed at other components, and the various components may be combined or separated. Other modifications also may be made.

In order to acquire a new vehicle, the consumer who intends to dispose of their current vehicle must complete at least three major processes. These operations can either be performed online, in the traditional fashion at the dealership, or through a combination of both the online and traditional settings.

For example, if the consumer is using the Internet to complete these operations, then they are completed as follows. The consumer first selects the new vehicle, either by browsing through the inventory of vehicles that the dealer currently has on hand, or by using configuration software to select the vehicle and the various options desired. Next, the consumer determines the value of the vehicle that he or she is currently driving, and ascertains how or if the value derived from that vehicle will contribute to the acquisition of the new vehicle. Finally the consumer considers how he/she will pay for or finance the remainder, once the value of the current vehicle is subtracted from the cost of the new one.

Each of these steps needs to be completed in order for the consumer to acquire a replacement vehicle. The steps do not necessarily have to be performed in a serial fashion, and thus, some customers will first ascertain how much their trade-in is worth, while others will want to understand if their credit rating is adequate for them to finance a new vehicle. Most consumers will select the new vehicle first, and will generally do that by accessing a Web site operated by an vehicle manufacturer, an portal, and/or a franchised dealer close to their home or place of work.

Some systems may determine the value of a used automobile. A number of these systems also allow for this valuation to be conducted over the Internet. Examples include the National Automobile Dealers' Association (“NADA.”), which allows users to determine the value of a used vehicle through their Web site at www.nadaguides.com; and the Kelley Blue Book, which allows consumers to determine the value of a used car through their Web site at www.kbb.com.

However, these websites do not allow the consumer to obtain an actual offer on a vehicle from a dealer. As a result, other systems allow the consumer to obtain an actual offer for their used vehicle over the Internet using an interactive Web site. For example, one such site can be found at www.buyfigure.com. In order to obtain a price offer using this system, the consumer enters the VIN number for a particular vehicle and completes a questionnaire. This information is then submitted to the BuyFigure Web site where a price is determined for the vehicle. This price is returned to the user in the form of a demand certificate. This demand certificate can be used to sell the vehicle to any dealer that is franchised in the BuyFigure system.

Unfortunately, such systems have the significant disadvantage that they do not allow the dealer to customize an offer for the vehicle based upon dealer designated buying criteria. This is a significant disadvantage, since particular dealers may want to adjust their offer price based upon factors that are of importance to them specifically. Moreover, such sites do not refer the consumer (and generate leads) from the dealer's own Web site. This is a significant disadvantage as such systems can not readily be used as a lead generating engine for specific participating dealers.

Accordingly, a system is needed that serves both the consumer and the automobile dealer; and which enables a dealership to ascertain the actual wholesale value of the vehicle and to alter the offer price or other estimated value based upon the dealer's current buying criteria. The system may also enable consumers who are seeking to part with their current vehicle to secure a firm offer from a participating dealer, who is willing to purchase the vehicle.

In addition, consumers continue to desire more transparency in the financing process (e.g., finding financing resources to purchase a vehicle) from dealership's finance departments as a result of the greater availability of online vehicle pricing and online access to trade values. In many dealerships, the financing process may be a completely separate transaction handled after the sale is arranged between a car salesman and a consumer. As a result, some sales may fall through after a sales agreement has been reached because of consumer credit issues. Such inefficiencies in the financing process may create unnecessary delays and operating inefficiencies.

The financing process may vary widely from dealership to dealership. Since many consumers are used to the free flow of data provided by the Internet, such inconsistencies among dealerships may cause consumers to become frustrated with the financing process and result in poor consumer service and lost sales.

Currently, consumers desiring access to their credit score are limited to paying to access the credit score from a credit reporting agency (e.g., the Experian credit reporting agency, the Equifax credit reporting agency, the Transunion credit reporting agency) or applying for financing resources (e.g., an automobile loan) with the financing department of a dealership (which could result in lowering a consumer's credit score).

A dealership website may provide access to credit applications and preapprovals using one or more hyperlinks. These credit applications, however, may be lengthy and request the consumer to provide highly confidential information (e.g., a social security number). Furthermore, such a dealership may manage the credit application generated from their website by having an internet manager print out the credit application and hand-carry the credit application to a sales manager. The sales manager may then initiate a credit agency inquiry (e.g., request the credit report of the consumer from a credit agency, request the credit score of the consumer from a credit agency), which may result in a credit inquiry being added to the consumer's credit history or credit report. The addition of credit inquiries to a consumer's credit report may reduce the consumer's credit score. Once the credit report or credit score of the consumer is received, the credit application may be delivered back to the internet manager or to the sales manager based on whether the credit worthiness of the consumer is sub-prime (e.g., having a credit score below 630). Such management of credit applications may be highly inefficient and cause substantial operating delays at the dealership.

Consumers increasingly desire to manage their credit history by maintaining knowledge of events that may effect their credit worthiness. Accordingly, many consumers subscribe to credit monitoring services that routinely monitor the consumer's credit and credit history. Such credit monitoring services, however, are associated with a monthly fee and many do not provide a consumer with the option of viewing their credit score.

A web-based credit score service (or feature) may provide a consumer with an accurate estimate of the consumer's credit score (e.g., a credit score range) before the consumer visits a dealership. Accordingly, the consumer's credit score estimate may help manage the buying process at the dealership. A consumer may have greater comfort in the financing process as a result of knowing the estimated credit score upon which financing rates may be determined. In addition, the dealership may benefit from knowing the credit worthiness of a consumer up-front. Such knowledge may enable the dealership to better manage the vehicle purchasing process, reduce operating costs, and generate better sales results.

The web-based credit score service may utilize the organic Internet traffic that visits dealership websites to generate more sales leads (e.g., information that may be used to contact the consumer to arrange for the purchase of a vehicle). In addition, the credit score service may appeal to consumers that desire an expedited purchasing process without having to fill out lengthy credit applications that request highly confidential information (e.g., social security number) or generating credit report inquiries.

In some embodiments, the web-based credit score service may be accessible via one or more dealership websites. In other embodiments, the web-based credit score service may be accessible via one or more vehicle manufacturer's websites (e.g., Nissanusa.com, Chevrolet.com).

Accordingly, a system is needed to provide a consumer that is in the market to make a vehicle purchase with an estimate of the consumer's credit score without accessing the consumer's credit report and without requesting highly sensitive information from the consumer (e.g., a social security number). The system may output (e.g., display) a credit score survey to the consumer in response to the consumer activating (e.g., clicking on) a credit score service button (e.g., “ezCredit Score” estimate button) on a dealership's website. Based on the consumer's answers to the credit score survey, the system may determine (e.g., calculate) an estimate of the consumer's credit score using a scoring algorithm. The system may generate and transmit a sales lead in the form of an electronic message (e.g., email message) to a system (e.g., a car salesman's system) that indicates any, or a combination, of the consumer's estimated credit score, the consumer's contact information, and information associated with the consumer's vehicle of interest. Such systems are preferably accessible via the Internet and served to the consumer via an existing Web site operated by the dealership or an automotive portal.

It should be noted that the lead generation system is described with reference to generating vehicle sales leads to provide examples of use of the lead generation system. It is contemplated that the lead generation system may be used to generate any types of leads (e.g., information that may be used to contact a user interested in a particular item or service).

For example, the lead generation system may be used to generate real estate sales leads. In such an example, a real estate company may arrange to have the web-based credit score service accessible on the real estate company's website. Consumers interested in purchasing real estate property may visit the real estate company's website and may use the web-based credit score service feature to gain access to an estimate of the consumer's credit score. The consumer may input contact information and information indicative of the real estate property that the consumer is interested in purchasing. The information indicative of the real estate property may include any, or a combination, of the address of the real estate property (e.g., street address), the price of real estate property, and the type of the real estate property (e.g., single family home, townhouse, condominium). In addition, the web-based credit score service feature may transmit one or more sales leads (and the contact information and information indicative of the real estate property) to a system associated with the real estate company based on the estimated credit scores that were determined on behalf of the consumers. Based on the received sales leads, a realtor associated with the real estate company may contact one or more consumers to arrange for the purchase of one or more real estate properties.

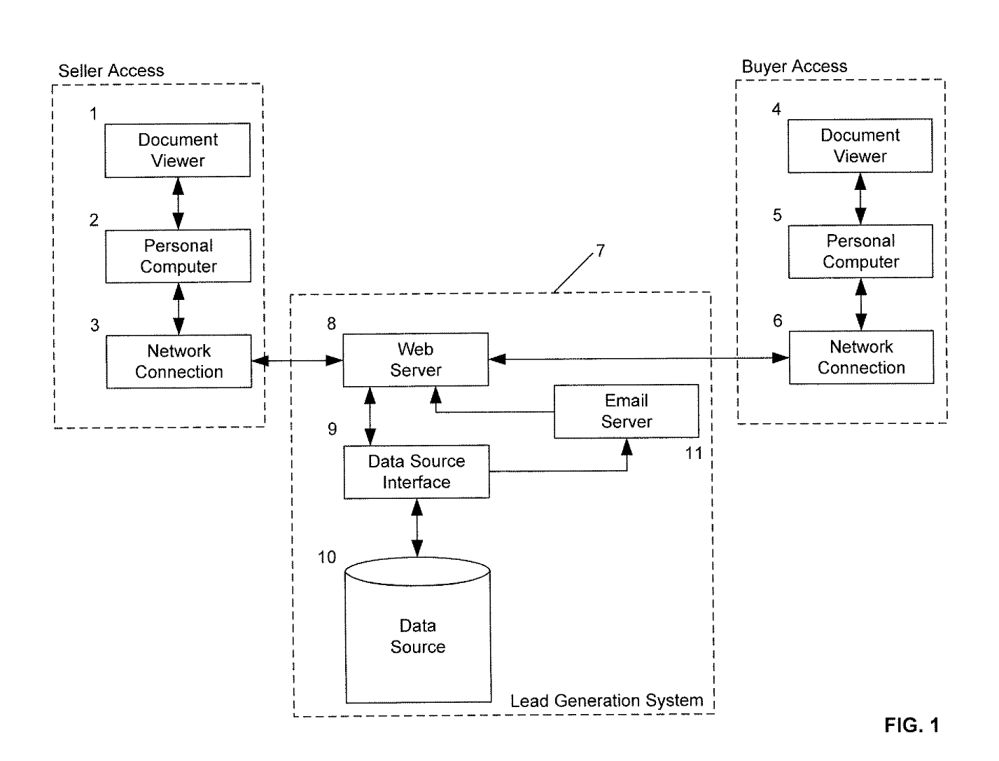

FIG. 1 is a schematic demonstrating the typical components used in a preferred embodiment of the invention when used over the Internet. Those of ordinary skill in the art will appreciate that the present invention, while described below in connection with its use over the Internet, is certainly not limited thereto.

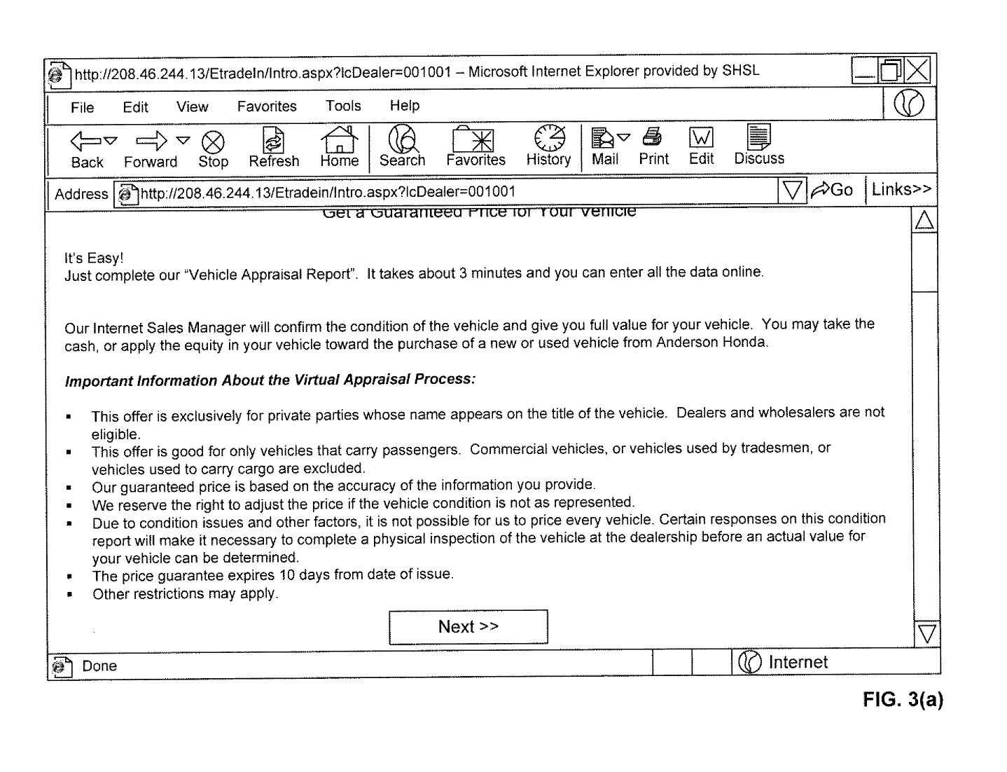

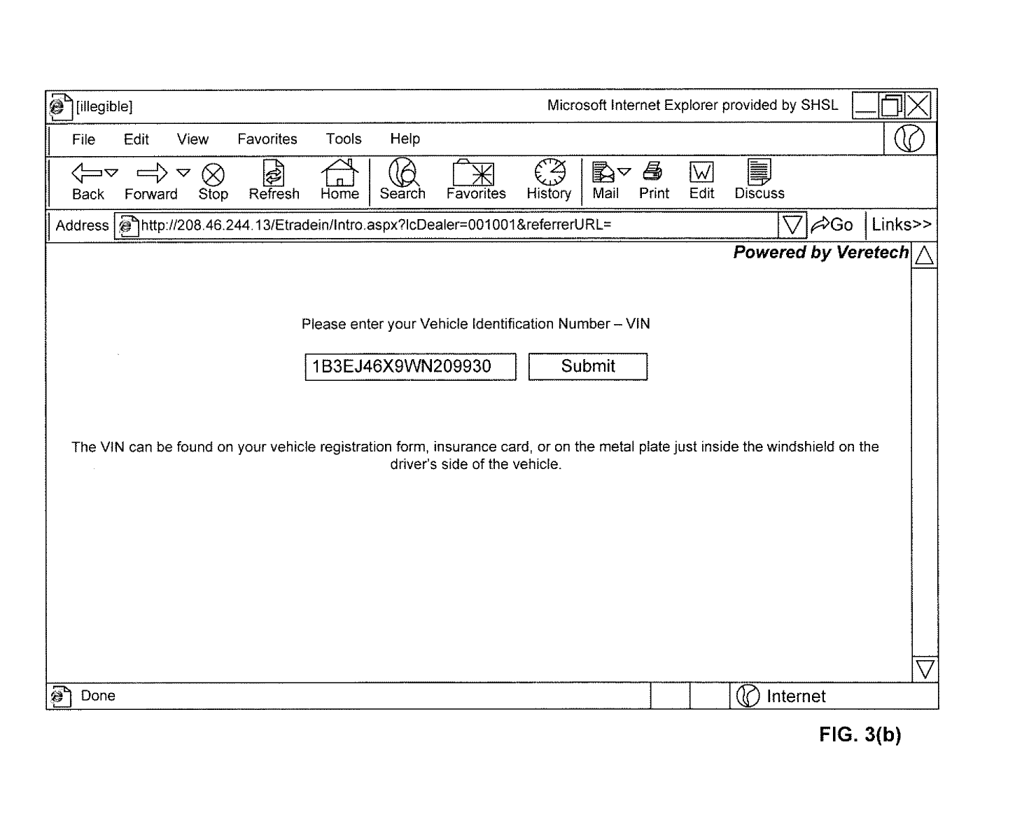

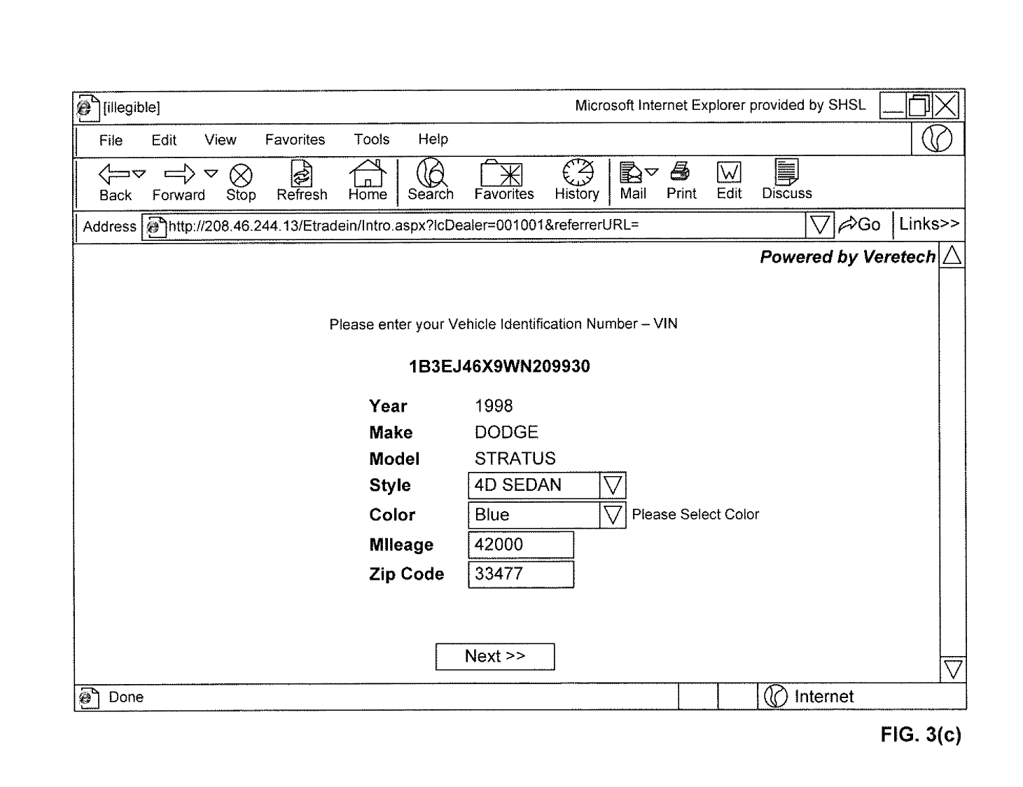

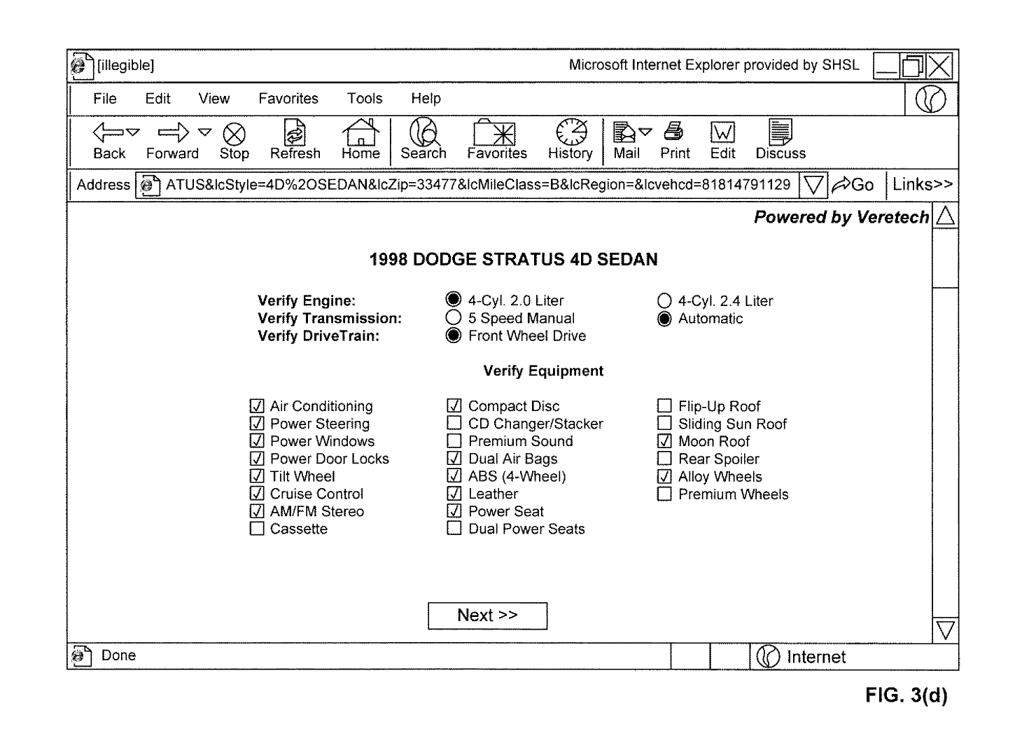

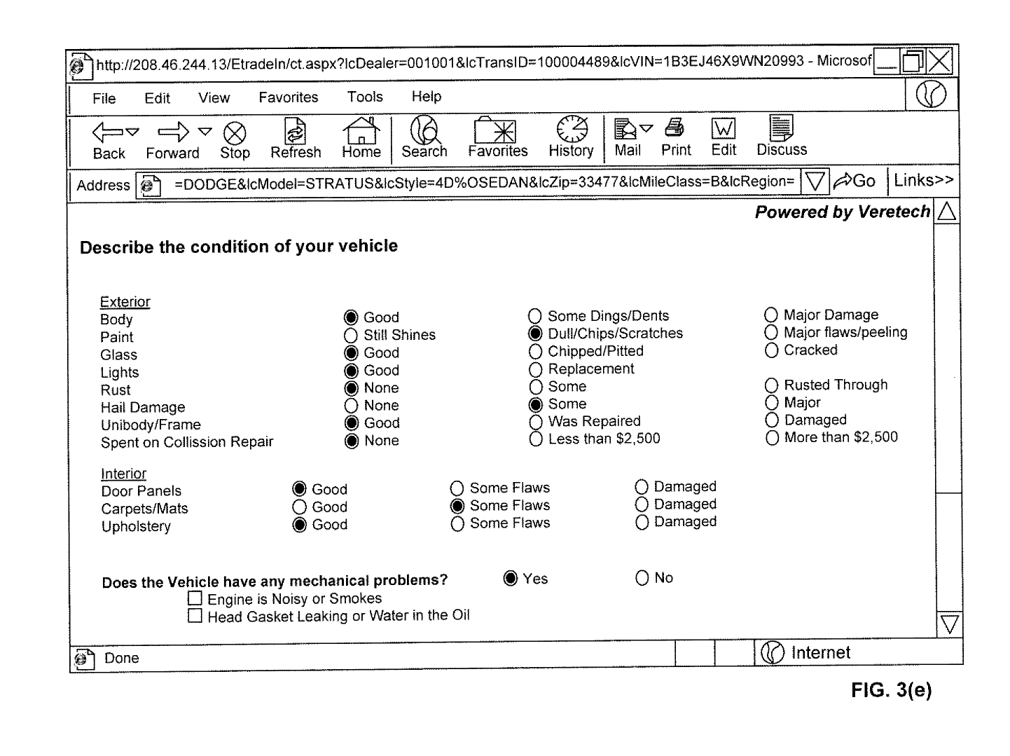

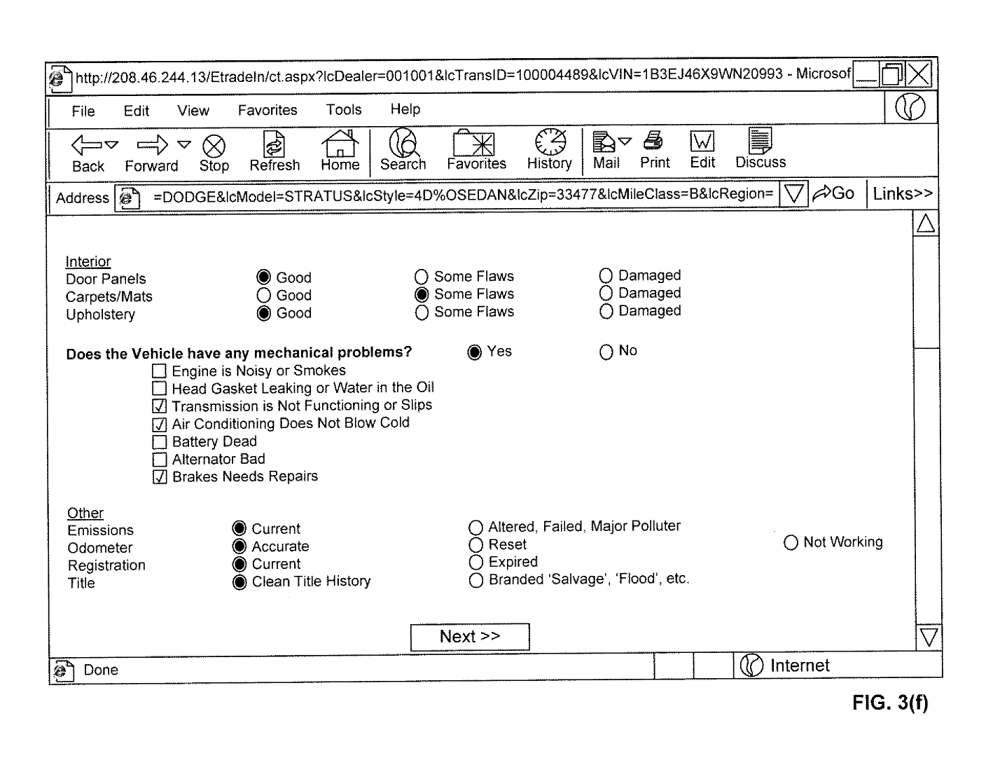

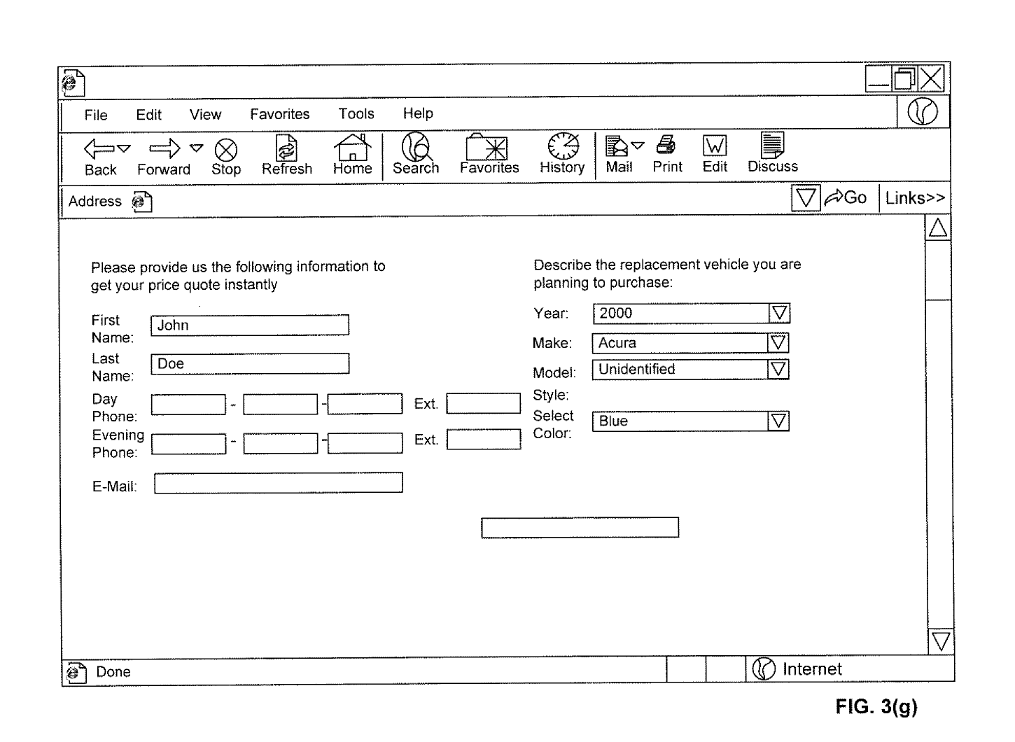

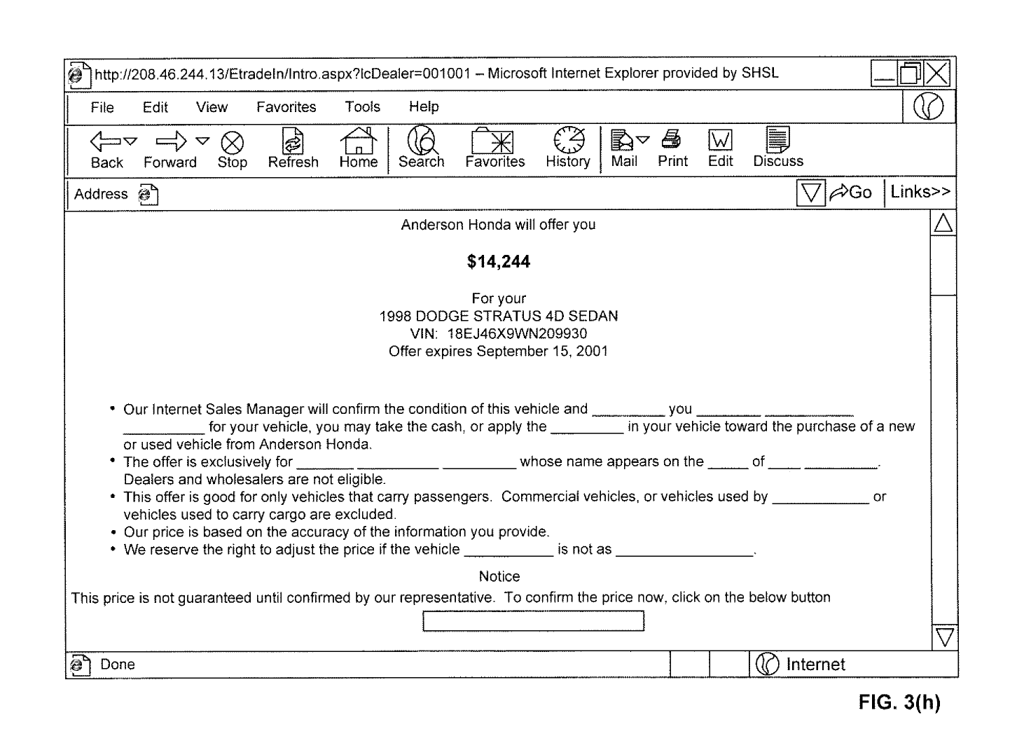

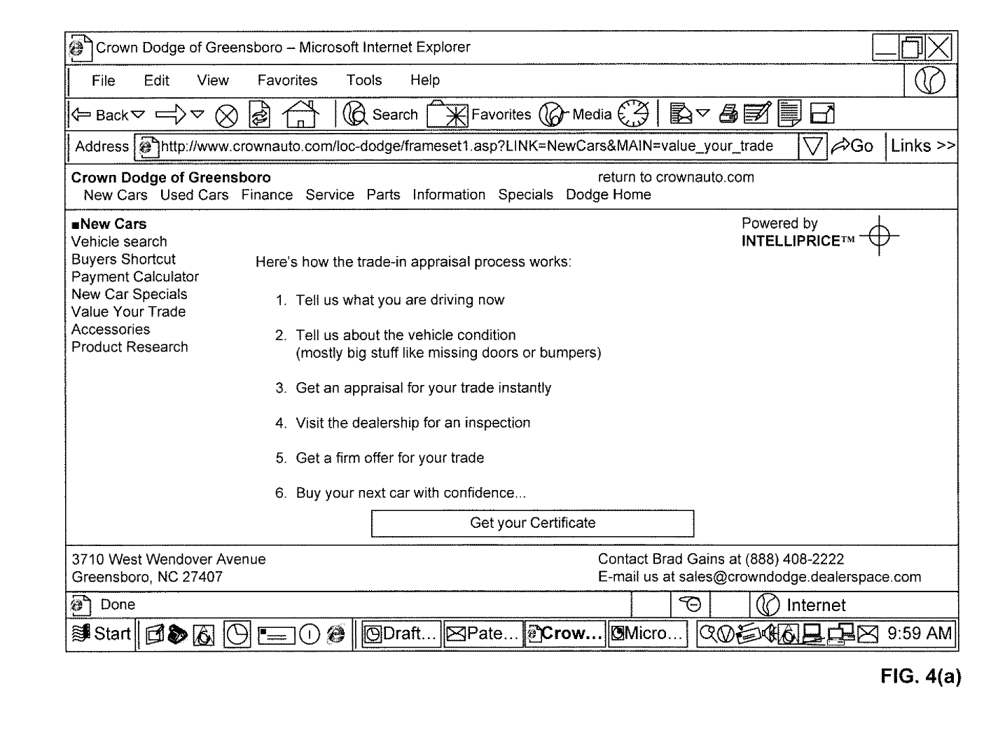

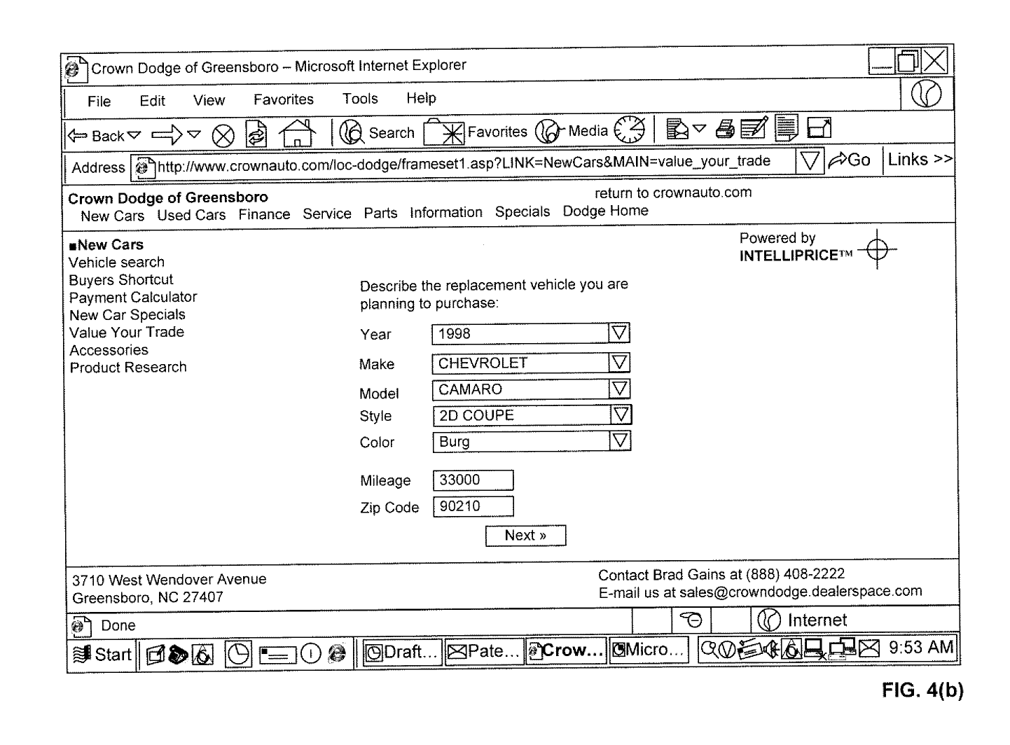

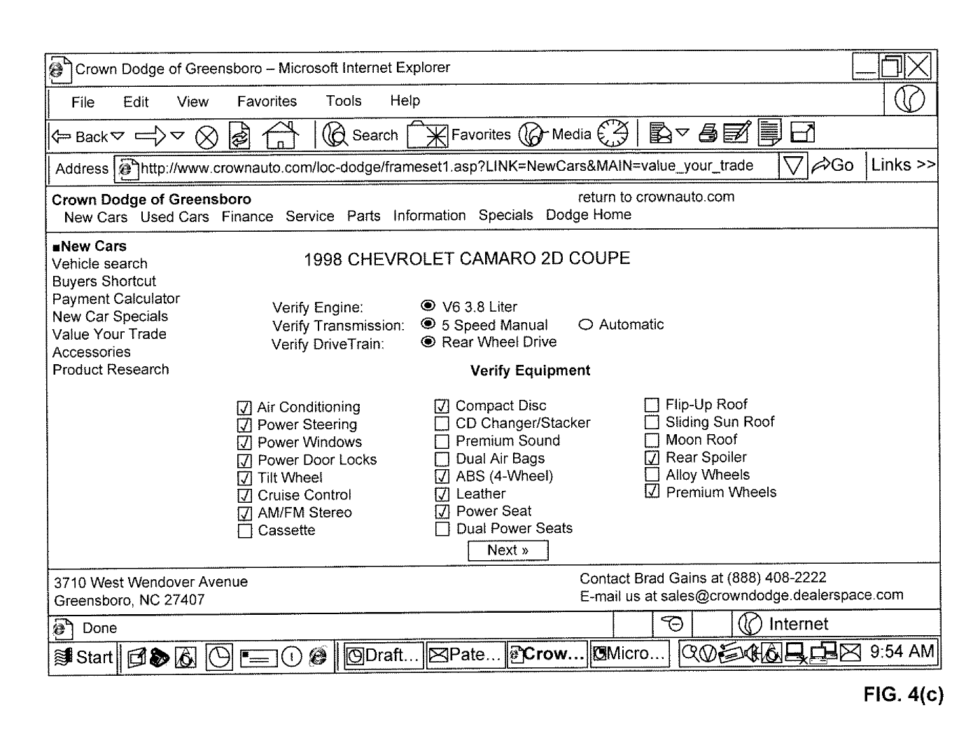

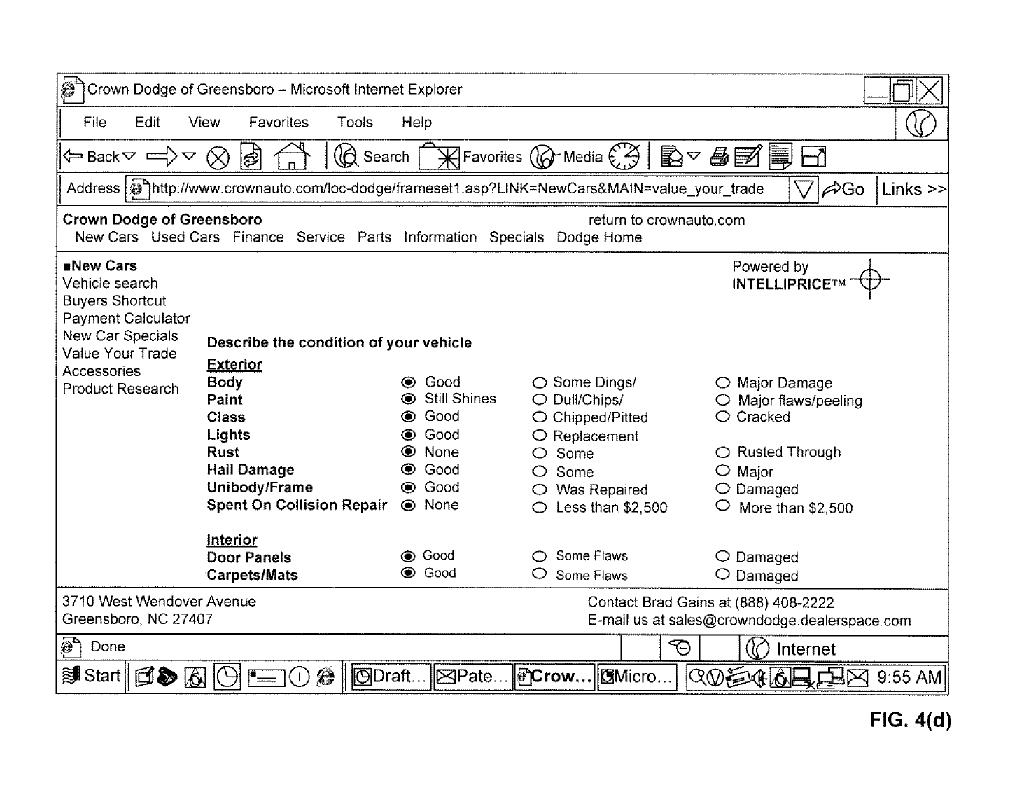

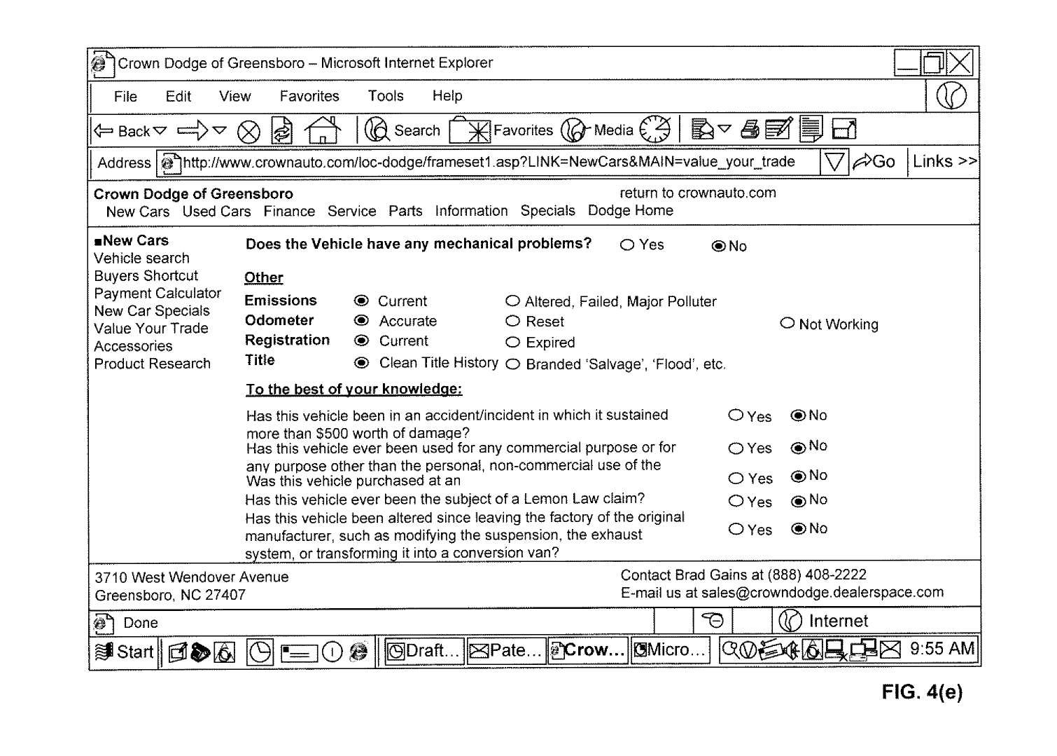

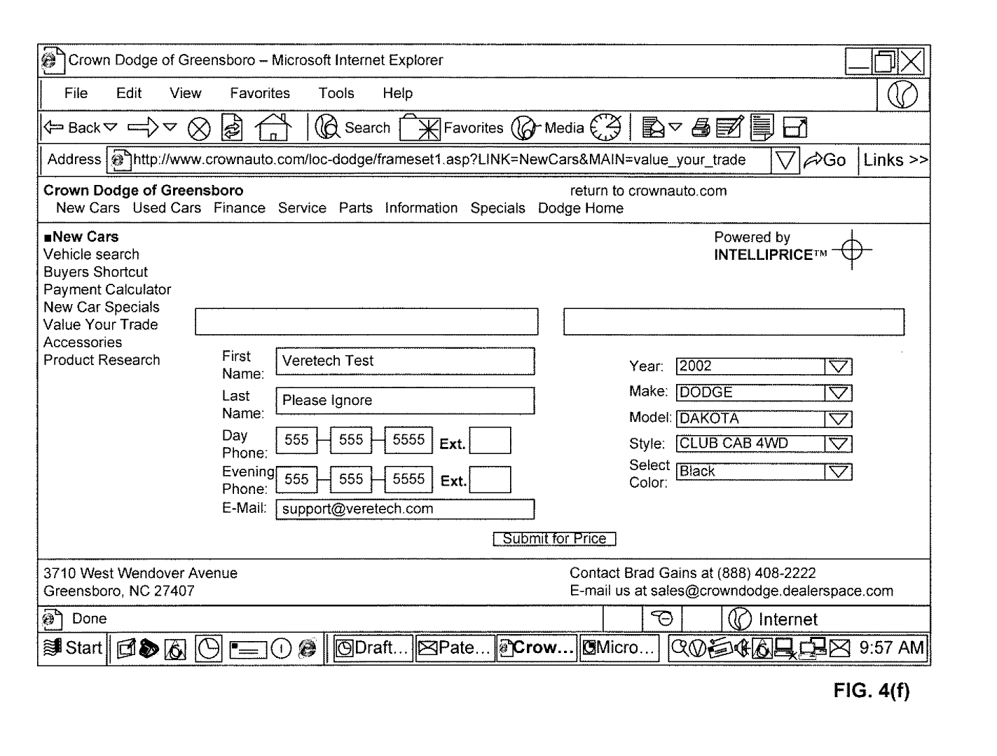

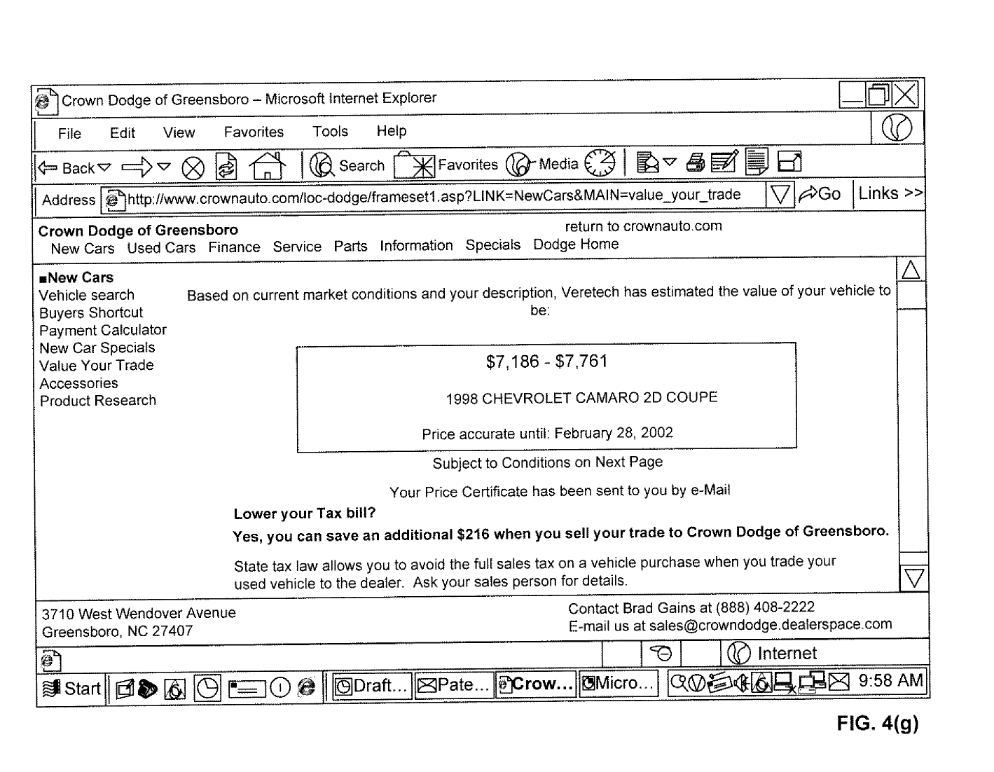

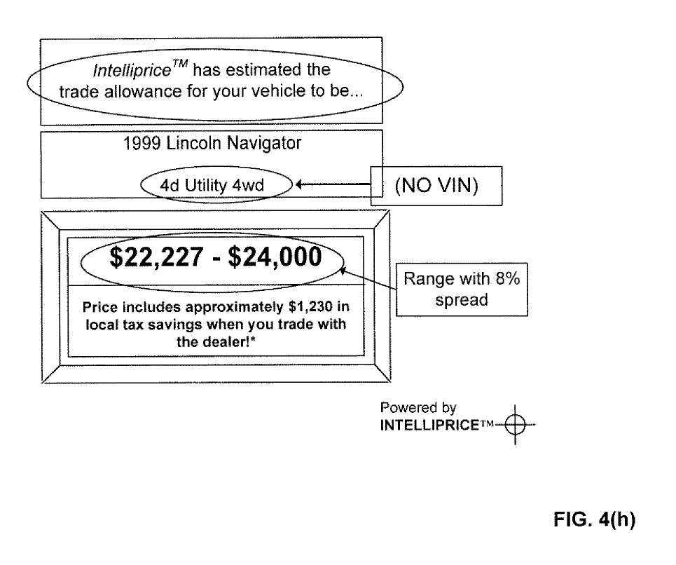

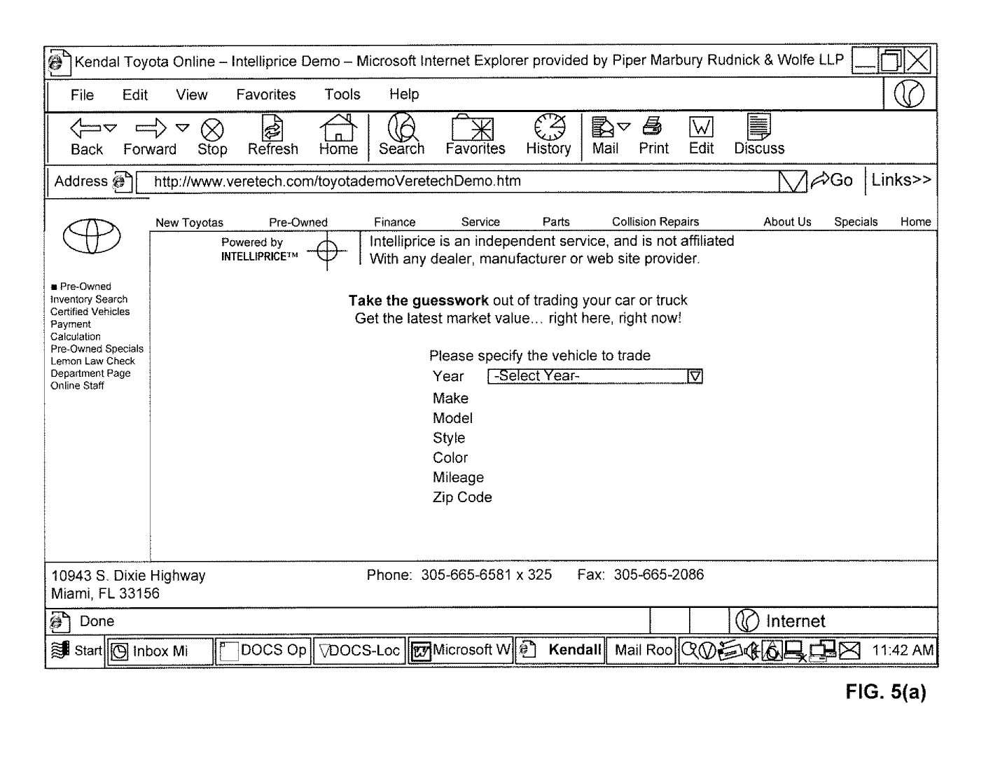

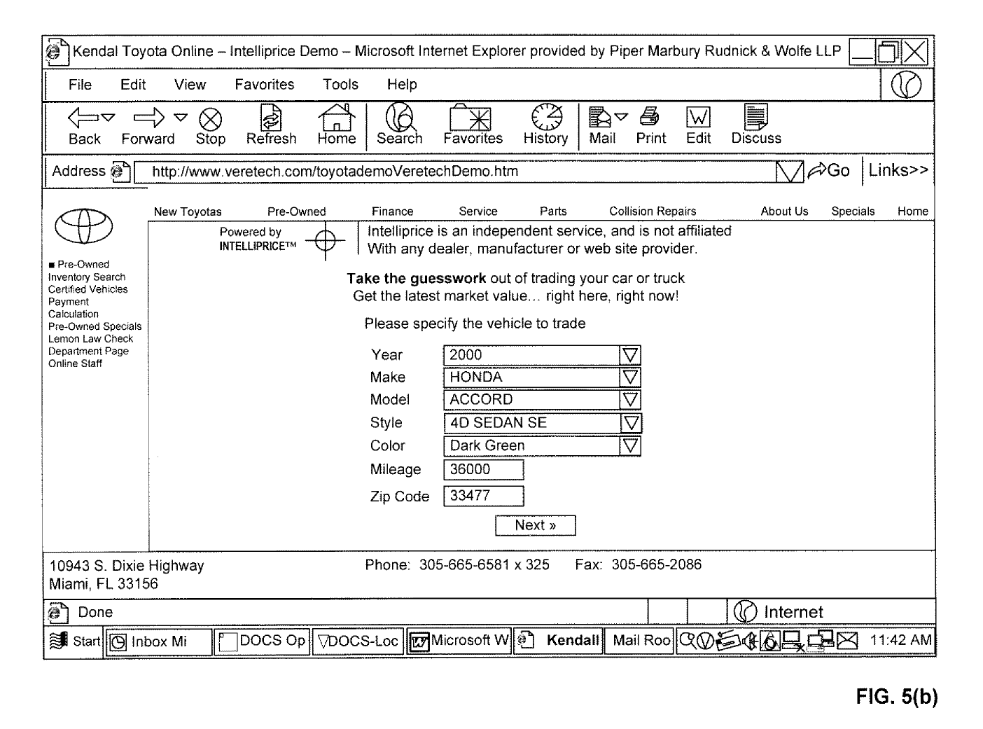

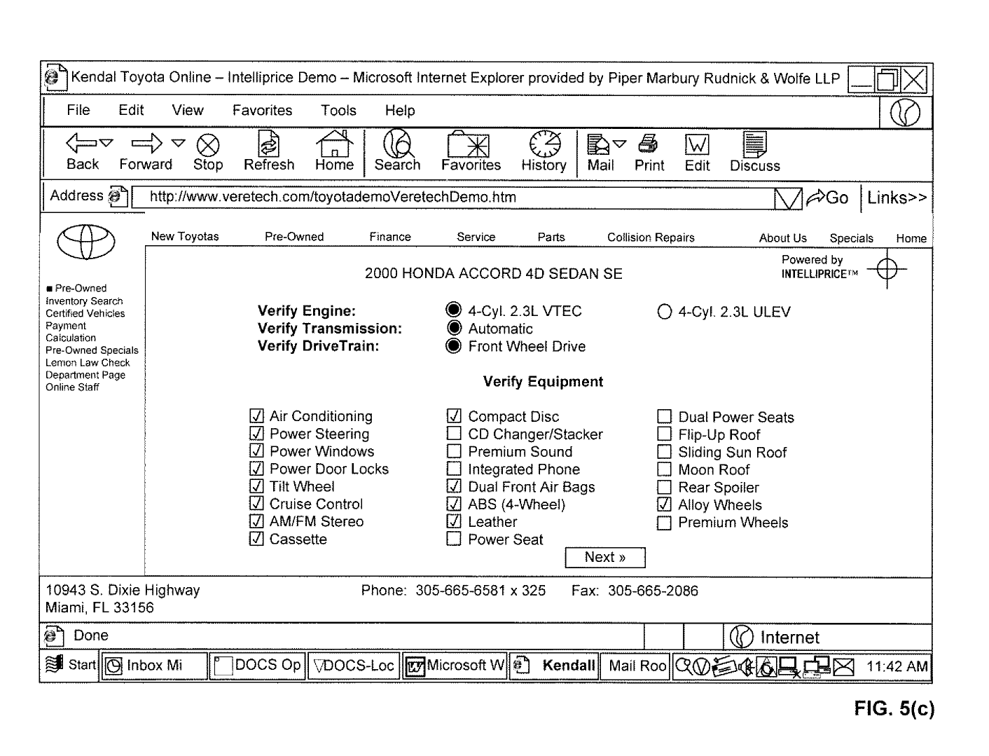

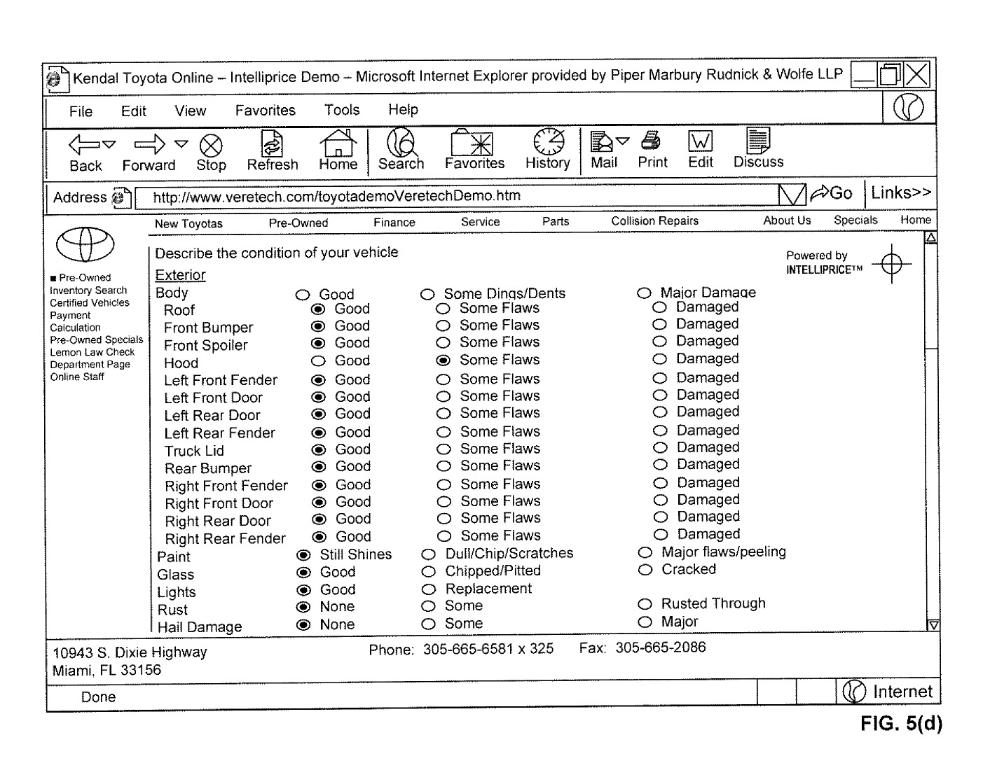

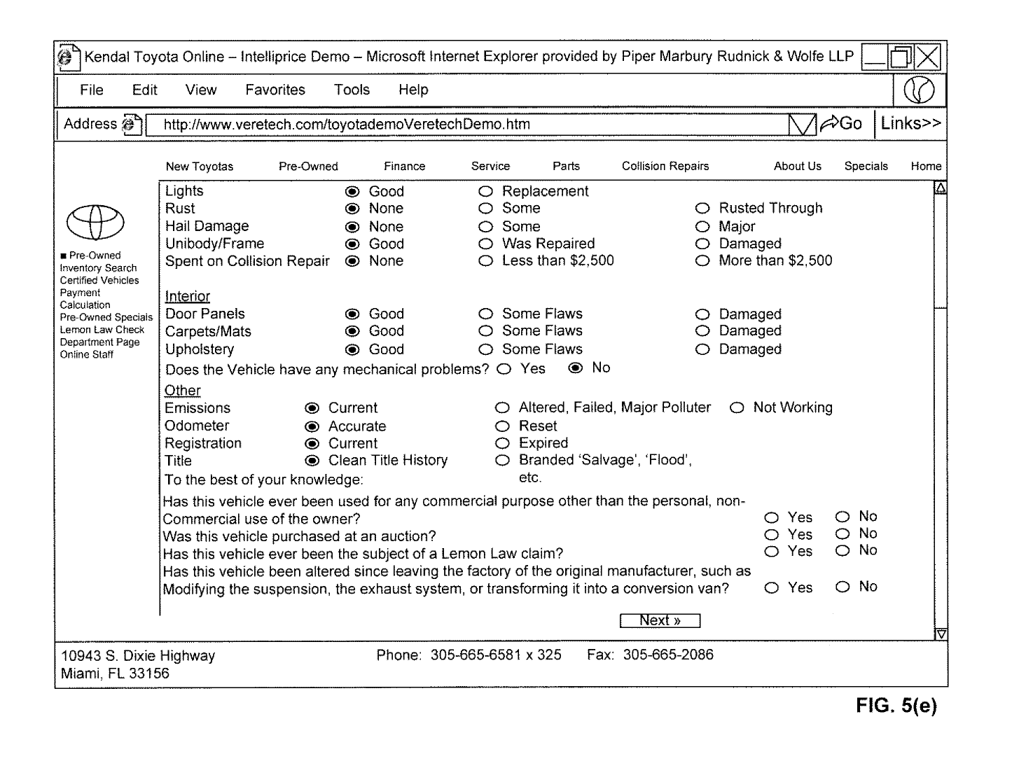

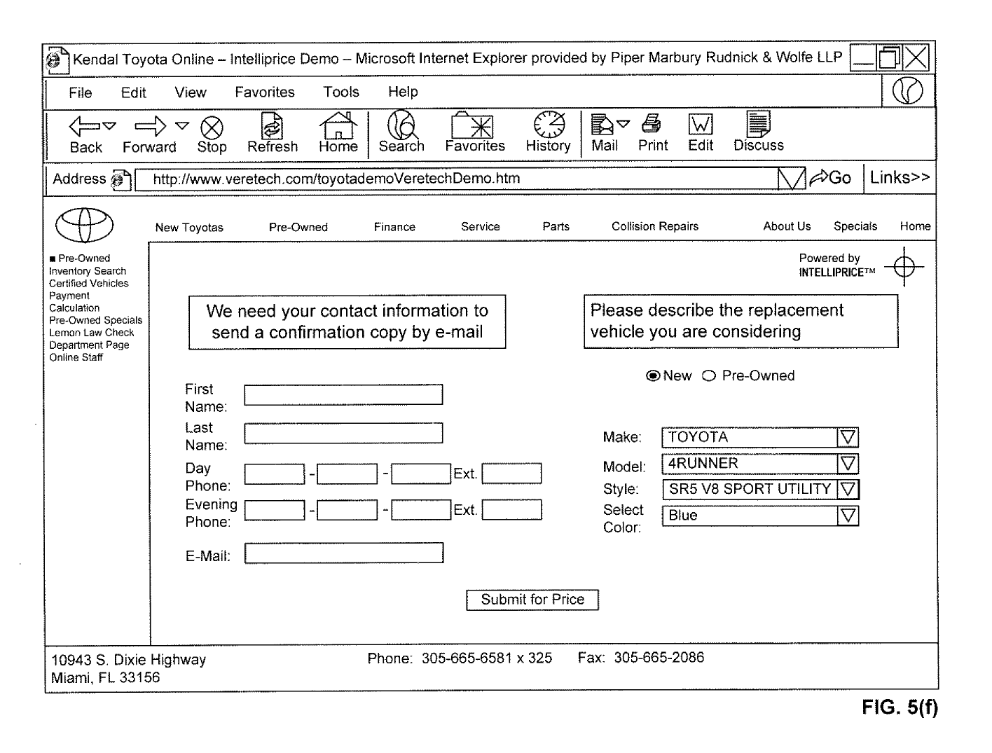

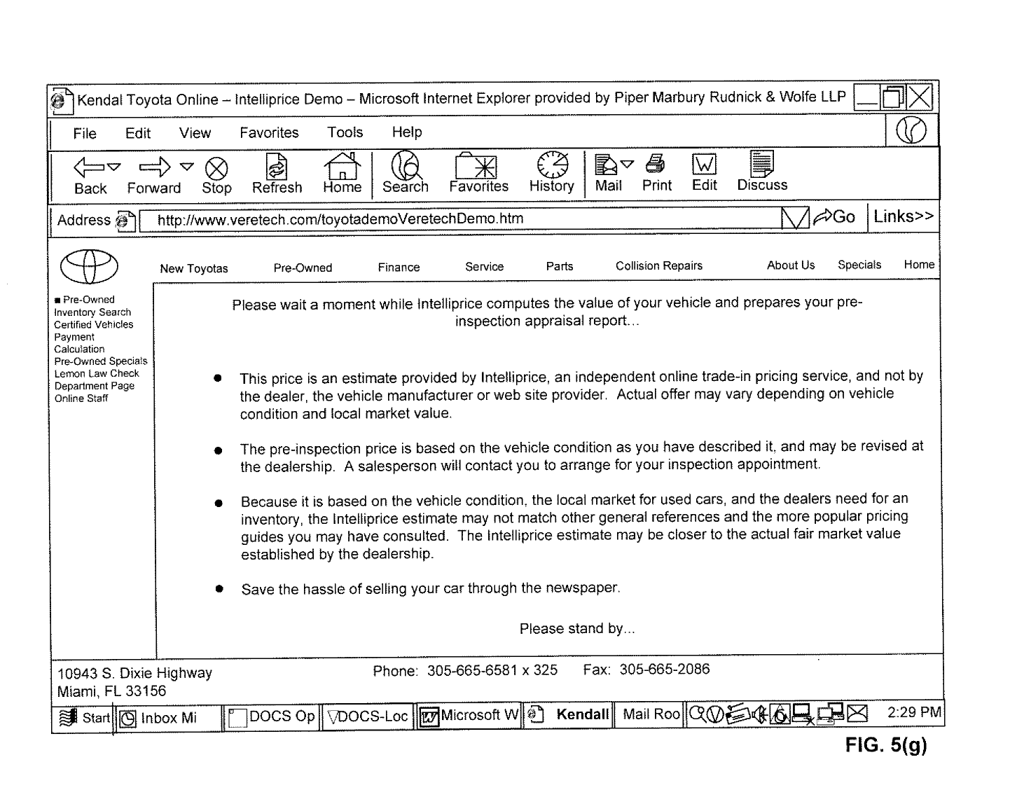

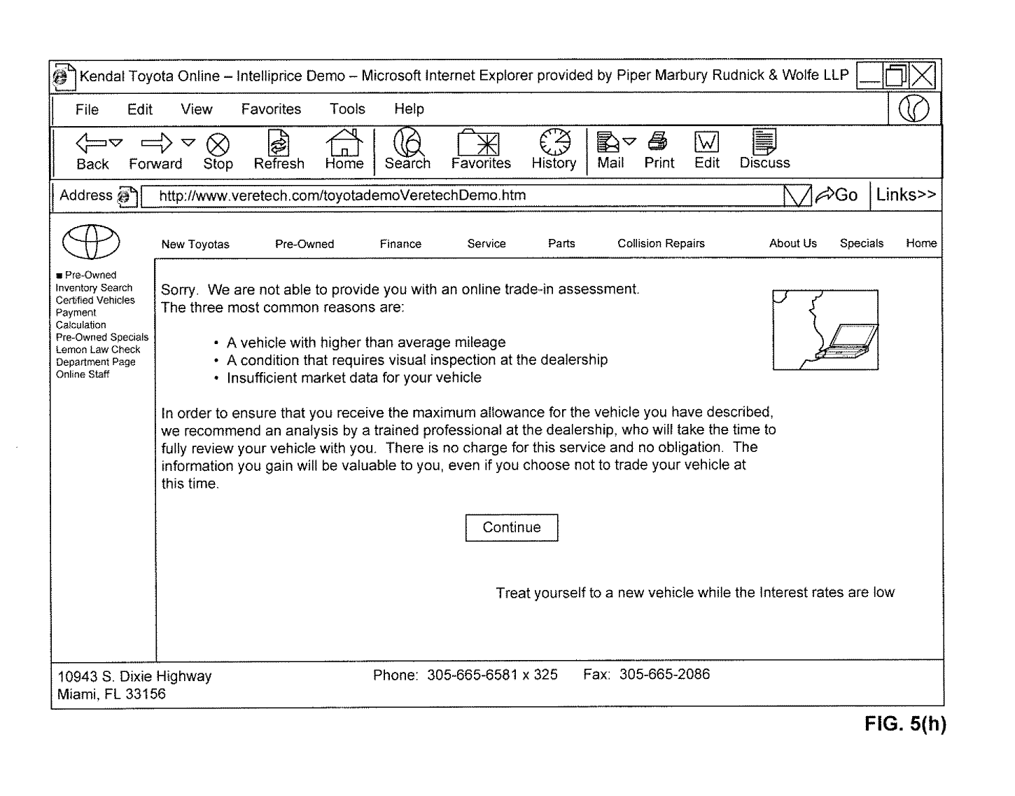

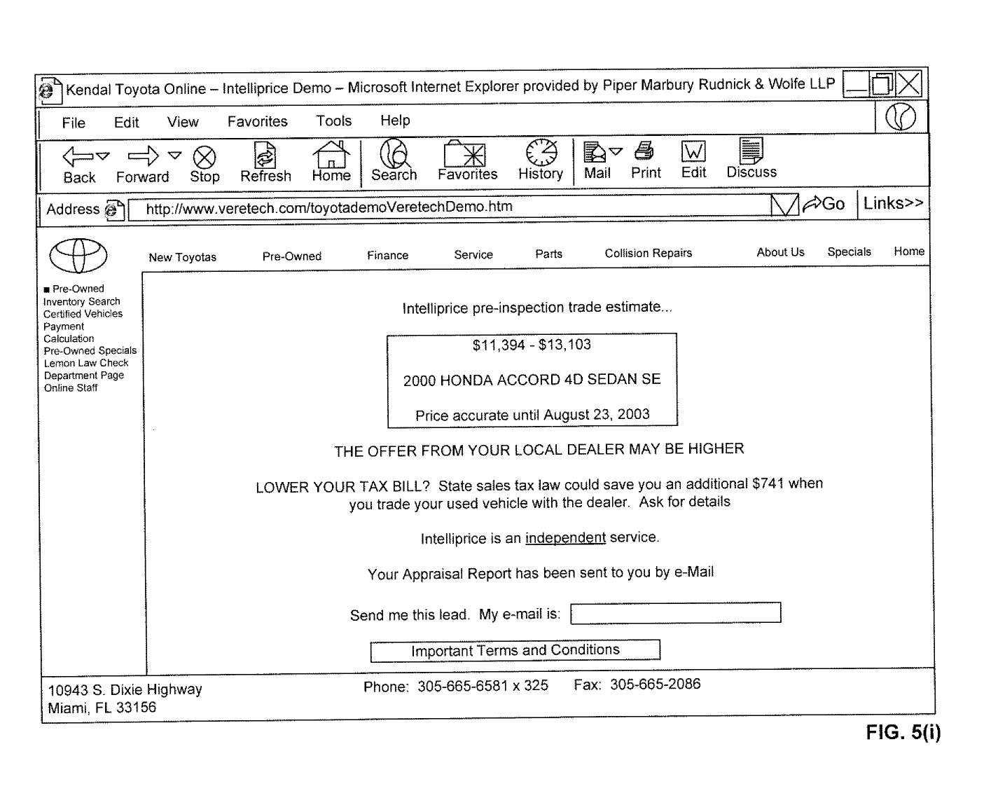

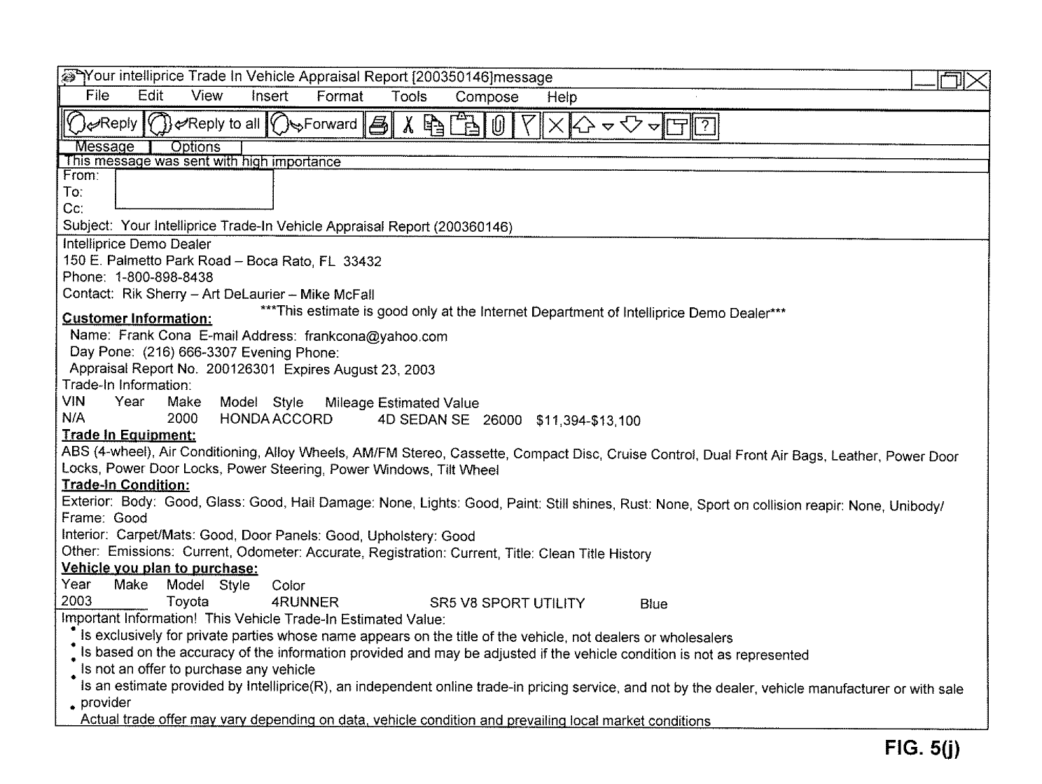

As shown in FIG. 1, this embodiment of the invention includes Seller Access, which includes Document Viewer 1, Computer 2, and Network Connection 3 (described in more detail below), which allows sellers to access the system of the present invention. The seller is preferably a consumer but is not limited thereto and may be businesses, other dealers, etc. A seller as referred to in FIG. 1, FIG. 3(a)-(h), FIG. 4(a)-(h), and FIG. 5(a)-(j) may include a user that desires to sell a trade-in vehicle to a dealership and/or purchase a new vehicle from a dealership. A buyer as referred to in FIG. 1, FIG. 3(a)-(h), FIG. 4(a)-(h), and FIG. 5(a)-(j) may include a dealership that desires to sell a vehicle to a user (e.g., consumer, seller) and/or purchase a trade-in vehicle from a user (e.g., consumer, seller). A user as referred to in the figures may include any person or entity that accesses or uses the features described herein. A consumer as referred to in the figures may include any person or entity that is in the market to make a purchase (e.g., purchase a vehicle, purchase a service, purchase real estate property).

The present invention also preferably includes Buyer Access, which includes Document Viewer 4, Computer 5, and Network Connection 6.

Seller Access and Buyer Access communicate with each other and have their transaction facilitated by, Lead Generation System 7. Lead Generation System 7, preferably includes at least an Internet Web Server 8, a Data Source Interface 9, a Data Source 10, and an Email Server 11.

To input and extract information from Lead Generation System 7, an electronic document, such as a Web page, is loaded in a conventional manner into a Document Viewer. Each Document Viewer may be any software application capable of viewing electronic documents and loading additional electronic documents from within the original document, such as through the use of a hypertext link or form (although not limited thereto).

For example, the Document Viewer could include a Web browser, such as Navigator from Netscape Communications, Microsoft's Internet Explorer, Safari, Firefox, or Mozilla. The electronic document may be loaded automatically when the Document Viewer is first started, or may be opened into the viewer by the user from a file stored locally or at a remote address. For example, the user may load the document by typing the document's address into the Web browser's command line.

Each Document Viewer may be accessed by the user through any of a number of computer systems, such as through the use of a terminal connected to a mainframe system, from a personal computer, or over computer connected to a local computer network.

Each Document Viewer is connected to the Internet along with each respective Computer, through each Network Connection. The Network Connection is typically made through local telephone lines using an analog connection, ISDN connection, DSL connection, wireless connection, or a cable modem connection, though it can be over a direct network connection, such as an Ethernet network and leased line. Each Network Connection may be a computer network that routes any requests from each Document Viewer to the appropriate location on the Internet. This operation is well known to those of skill in the art. The Network Connection connects its Document Viewer to Web Server 8 in Lead Generation System 7 through any of a number of well-known connection schemes, such as through the use of leased lines.

Web Server 8 is typically a software application running on a computer that is capable of forwarding or processing requests from the Document Viewer. For example, Web Server 8 may include any one of a number of well-known server applications, such as the NSCA Web server, the Apache Web server, etc. Web Server 8 passes a document request from the Document Viewer to Data Source Interface 9 for accessing Data Source 10. Data Source 10 contains all of the information provided by the Seller or Buyer as described in more detail below.

After a document, such as an HTML form (or series of forms), is loaded into the Document Viewer, the Seller enters in the appropriate information and activates a hypertext link or form “Submit” button, generating a signal back to Data Source Interface 9, as described in more detail below. This is preferably in the form of an HTTP request sent over the Internet using TCP/IP and possibly a Secure Socket Layer (“SSL”). The request may be routed through the Network Connection and through Web Server 8 to Data Source Interface 9. It will be appreciated that the details of HTTP operation in conjunction with TCP/IP and SSL are well known to those of ordinary skill in the art and will, therefore, not be elaborated on here.

When the HTTP request is received by Data Source Interface 9, it may access Data Source 10 to retrieve requested information based upon the signal from the Document Viewer, may store information received from the Document Viewer, may perform calculations using the received information, or any combination of these steps. In one embodiment of the invention, a common gateway interface (“CGI”) program, well known to those of skill in the art, may be used to parse the data from the Document Viewer. This program acts as an interface between the Web Server 8 and/or Data Interface 9 and Data Source 10 by executing a set of instructions. The interaction of Web servers and CGI programs and the sending of information therebetween is well known to those of ordinary skill in the art.

The CGI program may extract the document information from the information passed to it by the server and retrieve the appropriate information from Data Source 10. This may be accomplished in a number of ways known to those of ordinary skill in the art. For example, the CGI program may be a database access module of one of a number of commercial available relational database applications. Examples of such databases include Oracle, Sybase, SQL Server, and the like. It is also possible for these systems to be accessed directly by Web Server 8 using their own internal data engines.

Information is submitted to or extracted from Data Source 10, depending on the signal sent by the Document Viewer. Data Source Interface 9 then generates a signal back to the Document Viewer through Web Server 8. Email Server 11 may also be used to communicate with Buyer or Seller, preferably using a known transmission protocol, such as SMTP (Simple Mail Transfer Protocol) or by posting the information to a Web site where the recipient's application may process it further.

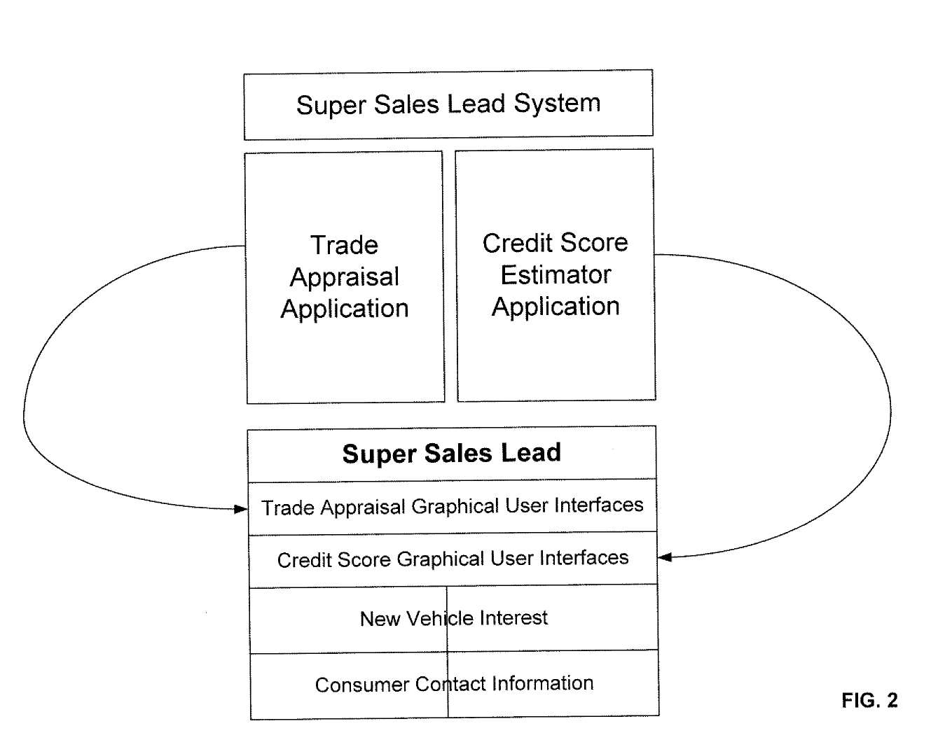

FIG. 2 is an exemplary diagram of a super sales lead system in accordance with the system of the invention. As illustrated, a user may access one or more lead generating features using a graphical user interface associated with the Lead Generation System 7. In one embodiment, a user in the market to purchase a new vehicle and/or trade-in a used vehicle may access the trade appraisal application by activating (e.g., clicking on) a “Trade Appraisal” button. In response to the activation of the “Trade Appraisal” button, the Lead Generation System 7 may activate one or more trade appraisal graphical user interfaces. Exemplary computer screen shots of the one or more trade appraisal graphical user interfaces are illustrated in FIGS. 3(a)-(h), 4(a)-(h), and 5(a)-(j).

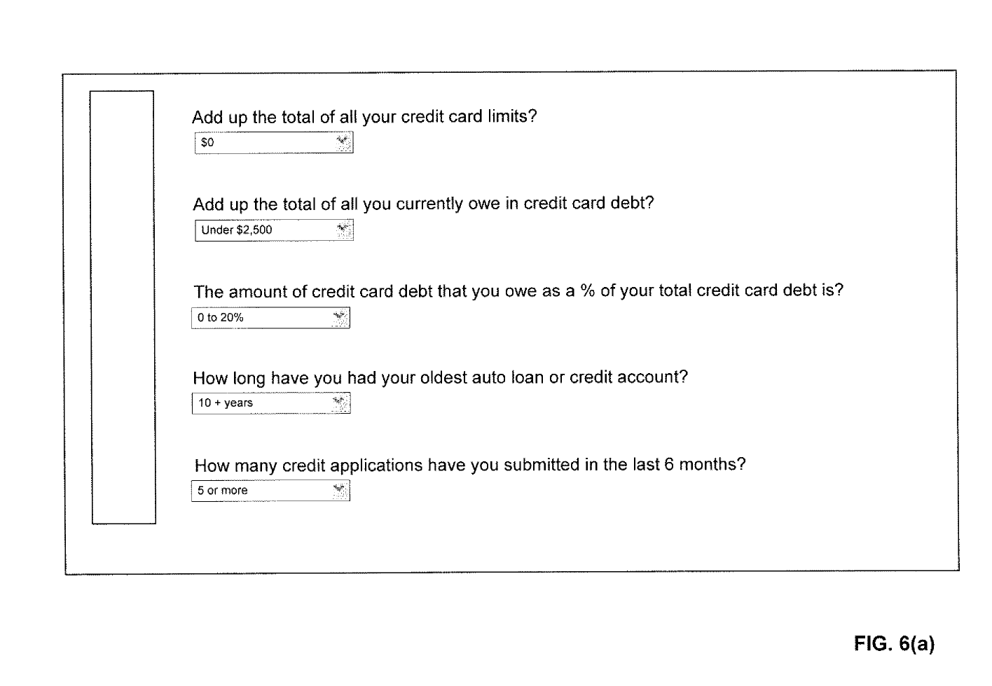

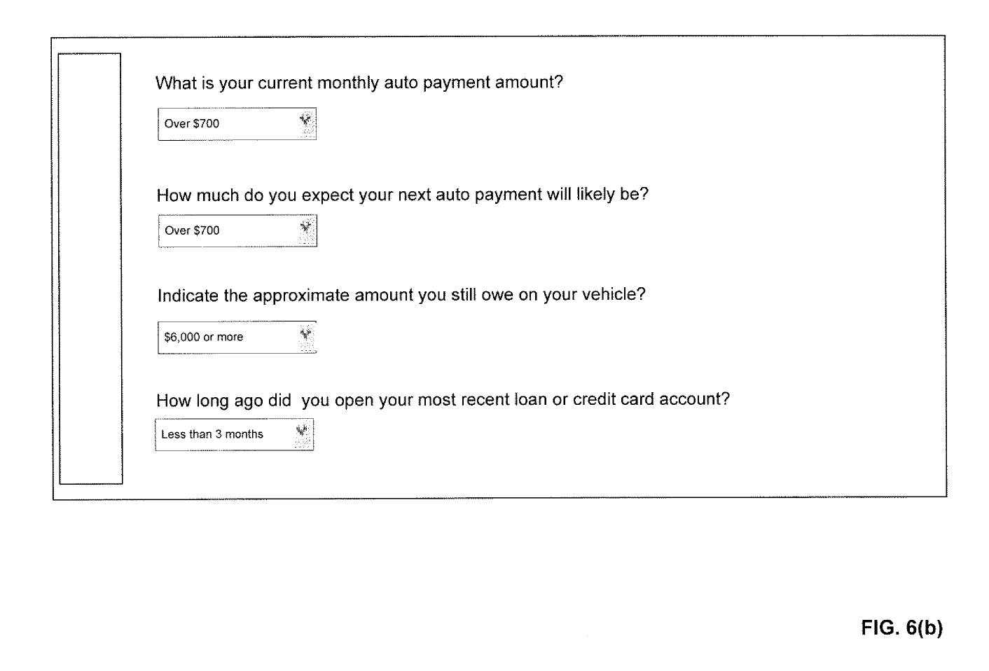

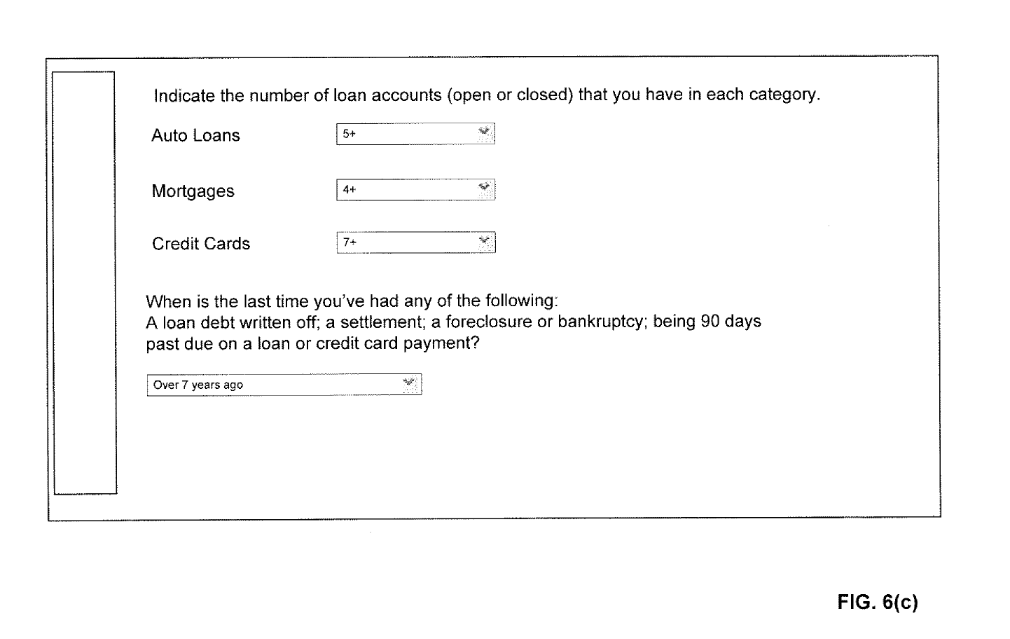

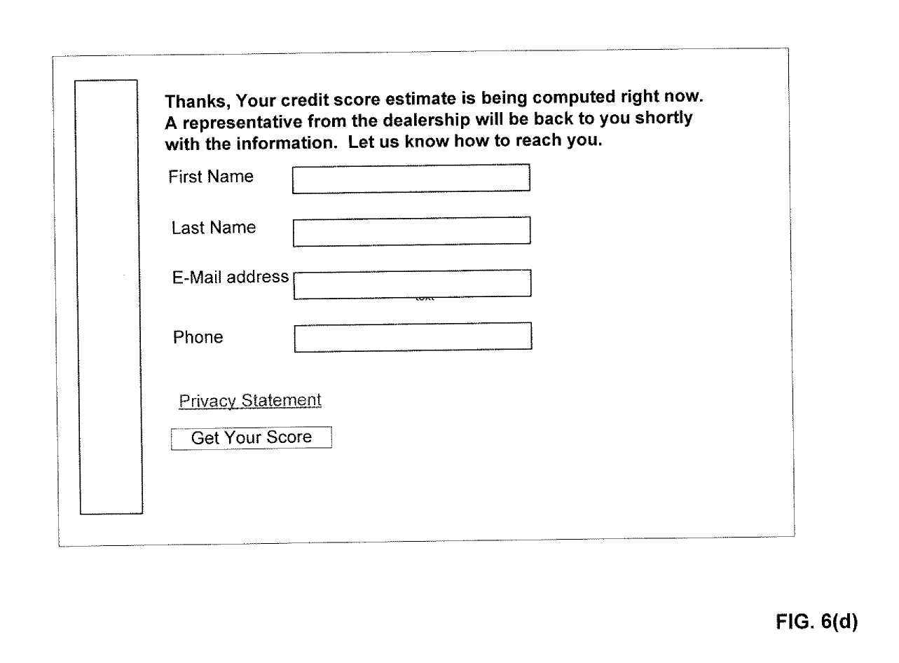

In another embodiment, a user in the market to purchase a new vehicle may access the credit score estimator application by activating (e.g., clicking on) a “Credit Score Estimator” button. In response to the activation of the “Credit Score Estimator” button, the Lead Generation System 7 may activate one or more credit score estimator graphical user interfaces. Exemplary computer screen shots of the one or more credit score estimator graphical user interfaces are illustrated in FIGS. 6(a)-(d) and 8.

In one embodiment, a user that accesses the one or more trade appraisal graphical user interfaces may be enabled to access the one or more credit score estimator graphical user interfaces by activating (e.g., clicking on) a “Credit Score Estimator” button displayed on at least one of the one or more trade appraisal graphical user interfaces. In another embodiment, a user that accesses the one or more credit score estimator graphical user interfaces may be enabled to access the one or more trade appraisal graphical user interfaces by activating (e.g., clicking on) a “Trade Appraisal” button displayed on at least one of the one or more credit score estimator graphical user interfaces.

In one embodiment, a super sales lead may be generated as a result of a consumer interacting with the one or more trade appraisal graphical user interfaces and the one or more credit score estimator graphical user interfaces to input contact information, vehicle information, information indicative of a vehicle of interest, and answers to a credit score survey. The super sales lead may be transmitted to a system associated with a dealership in the form of an email and may include contact information, vehicle information, information indicative of a vehicle of interest, and an estimated credit score associated with a consumer.

FIGS. 3(a)-(f), 4(a)-(f), and 5(a)-(f) illustrate preferred embodiments of Web page forms used to submit the vehicle identifying and condition information to Lead Generation System 7. As shown in the Figures, the first of these forms preferably describes how the process works, what is required by the Seller, and any industry specific disclaimers to deal with existing commercial codes that affect the retail sale of vehicles, such as automobiles.

As shown also shown in the figures, the Seller is then asked to provide the vehicle identification information, such as the vehicle identification number (VIN) in the case of an automobile. While the make, model, style, and year of the vehicle may also be provided, this identifying information can also be determined from the vehicle records for the vehicle under the VIN. This information may be obtained, for example, from the Black Book, well known in art, which contains a breakdown of each manufacturer's VIN information, and may be stored in Data Source 10. It is also possible for VIN related information to be maintained by the state department of motor vehicles for the state in which the vehicle is registered and obtained in any number of ways well known to those of ordinary skill in the art, such as through direct access to the department's online database.

The Seller may then be prompted to indicate the “trim level” of the vehicle, i.e. the optional equipment or option packages with which the vehicle was equipped when it left the factory. The Seller may also be prompted to provide the number of miles that the vehicle has been driven since new. Finally, the Seller may be prompted for his/her zip code. The seller's zip code may then be matched with a dealer, based upon the dealer's zip code (which may be stored in Data Source 10). The zip code of the dealer is often an important factor to consider in establishing an accurate value for a vehicle.

The Seller may also be presented with a list of options that are standard trim packages for the vehicle, as well as a number of the most common options that may have been added to the vehicle. This gives the Seller the ability to describe the components of the vehicle in the most comprehensive and accurate manner, and helps to ensure that all of the options installed on the vehicle are taken into account when its value is being calculated.

The Seller may then be prompted to record an observation of the condition of the vehicle on a questionnaire. The questionnaire electronically emulates the process of the used car appraisal that is traditionally performed in person at the dealership. All condition flaws are noted, whether physical or mechanical, that might reduce the current wholesale market value of the vehicle. As each portion of the vehicle is reviewed, the consumer is prompted to comment on its condition, such as being “like new”, “fair”, or “damaged”. If the Seller marks any item as being something other than “like new”, the questionnaire can be expanded to probe more thoroughly as to what the exact flawed component is, and to record its current condition in greater detail.

Once all of the vehicle identifying and condition information has been provided, Lead Generation System 7 may prompt the Seller for contact information, including name, street address, phone number, and email address. A valuation system may also prompt the Seller to describe the new (or at least replacement) vehicle that the Seller is seeking. This information can also be used to generate the lead to the dealer. The Buyer (dealer) can contact the Seller in order to follow up on the Seller's interest and intent in disposing of the vehicle and procuring another one.

Once all of this information has been received by Lead Generation System 7, the valuation system may access an auction data source to obtain the relevant historical data, such as wholesale sales that occur at vehicle auctions and dealerships, for vehicles related to the vehicle that the Seller is offering or at least valuing for sale. The auction data source may comprise a single database of auction records or may comprise multiple sources of auction related information. Of course, this information may be manually entered into the valuation system, as well. For example, this information may be obtained from a variety of industry sources, such as Manheim, ServNet, ADESA, Digital Microworks, and/or National Auto Research (Black Book).

Once the historical data has been received, it may be used, along with vehicle identifying and condition information by Lead Generation System 7 to calculate an estimated value for the vehicle in real time. For example, one manner in which the estimated value may be calculated is by taking the historical information to determine a base value, adding for optional equipment, subtracting for excess mileage, and subtracting for physical and mechanical condition flaws. Preferably, Lead Generation System 7 will calculate the current average wholesale value for each vehicle based on auction results of the last few weeks within the geographic region of the dealership (Buyer).

Alternatively, the information may be sent to the Buyer to separately calculate a value for the vehicle. This information may be transmitted to the Buyer through any of a number of conventional means, such by email using Email Server 11, or by a facsimile generated by Lead Generation System 7 in a manner well known to those of ordinary skill in the art.

Lead Generation System 7 may then generate an offer price or estimated value for the vehicle using the initially determined value. This offer price may then be submitted by the Buyer to Lead Generation System 7, such as through the use of a Web page in a Document Viewer using Web Server 8 or by an email using Email Server 11. Lead Generation System 7 may then transmit this offer price to the Seller, similarly through a Web page in the Document Viewer using Web Server 8, or by an email using Email Server 11. This offer price may take the form of a demand certificate that the Seller can print and take to the Buyer to accept the offer or to keep in the Seller's records. An example of a demand certificate is shown in FIG. 3(h).

In the preferred embodiment of the invention, however, before submitting the offer price to the Buyer, Lead Generation System 7 may refine the price using any of a number of buyer criteria. The buyer criteria are preferably stored in Data Source 10 in a profile for each participating Buyer (dealer). These buyer criteria may comprise a set of rules selected by the dealer when establishing his/her profile in Data Source 10. The dealer profile may be established using an interactive set of web page forms.

The actual buyer criteria may comprise an number of factors, such as the “black book” value, well known to those of ordinary skill in the art, or offsets to price determined by trade-in or inventory incentives, etc. These may be selected (and modified) by the dealer from a list of items provided through the interactive Web forms.

For example, the buyer criteria may include a price control option, wherein pricing is restricted to a maximum of some predetermined percentage (preferably 0 to 10%) above the average price provided in the Black Book, NADA, or Kelley Blue Book; or the average wholesale price. This is further illustrated in Table 1.

TABLE 1

| Appraisal Value: | | Discount: | |
|---|---|---|---|
| From $5,000 | to $10,000 | reduce price by | $500 |
| From $10,001 | to $18,000 | reduce price by | $700 |
| From $18,001 | to $25,000 | reduce price by | $1,000 |
| From $25,001 | to $40,000 | reduce price by | $1,500 |

Vehicle specific buyer criteria may also be used. In other words, the average wholesale (auction) price on each vehicle may be reduced or increased a percentage based upon the Year, Make, Model, Style, and/or Color of the vehicle. These pricing rules will be used in addition to the general rules noted above.

Vehicles matching certain historical concerns may also be excluded from the aforementioned price adjustments, or even denied an offer/value altogether. Such historical concerns could include, for example, vehicles that have been used for commercial purposes, vehicles used by tradesmen, vehicles used to carry cargo, vehicles older than 1994 model year, vehicles with major damage or excessive condition flaws, vehicles with major hail damage or rust, vehicles that have sustained previous damage exceeding $2,500, vehicles with excessive mechanical problems, vehicles with faulty or inoperative odometers, and/or vehicles that have branded or salvage titles.

An offset for state sales tax may also be used as buyer criteria for modifying the offer to the Seller. For example, state tax tables can be used to show the difference between the tax on the purchase of a new car and the purchase of a used car. This difference may also be used to modify the offered value for the used vehicle accordingly. The estimated value may be provided, and the tax savings for that state may also be shown.

In one embodiment, such as is shown in FIG. 4(h), for example, this value may be presented to the Seller so as to clearly demonstrate that it is independently generated (i.e., not calculated by the dealer whose Web site the Seller has accessed or to whom the Seller may be in contact regarding the sale or disposition of the vehicle). This provides the significant advantage of greatly increasing the Seller's willingness to rely on the value provided and the perception that the value is fair, accurate, and/or unbiased. This, in turn, increases the chances that the Seller will approach that dealer.

Alternatively, however, the entire process may be done in a private labeling manner, so that the Seller is unaware that Lead Generation System 7 is calculating the estimated value independently of the dealer (if that is the case).

Once the lead is generated by Lead Generation System 7, it may then be provided to the Buyer (dealer) in any number of conventional manners (such as the systems described above), and stored locally by the Buyer in the dealer's own database. The lead is preferably transferred and stored in a format known and used by the industry and usable by known lead management software, such as iCarMagic, Reynolds Lead Manager, Applied Virtual Vision, Sale Enhancer, DealerPoint, and/or Car Client.

As noted above, in one preferred embodiment, the system of the invention may calculate an estimated value for a vehicle without requiring the VIN from the Seller. The Seller need merely insert the Year, Make, Model, Trim, Mileage and/or Zip. With advanced data mining techniques, the invention can derive the value at the auction, just as accurately as it would have had the VIN been used. This is a significant advantage. Many consumer don't have their VIN handy or just considered using the VIN too laborious to bother with. By eliminating this step, many more consumers will be able to use the invention.

As also discussed above, the system of the invention may provide an estimated value rather than an actual offer from the dealer to buy the vehicle. This has the significant advantage that the dealer will feel more comfortable about what is expressed to the consumer. Because sales tax savings may be added to the estimated value of the vehicle in order to maximize the value expressed to the consumer, this value is preferably shown as an estimated trade allowance rather than an actual offer to purchase the vehicle.

In addition, it is possible that a consumer may be disappointed with a proposed trade-in value that reflects a lower, wholesale value, and they may decline to engage in a dialog with dealership sales personnel. For example, depreciation rates on 2000 and 2001 vehicles, particularly SUVs have been extremely steep. Many consumers find that they owe more than their vehicle is worth. To remedy this situation to some degree, the estimated value of the invention be expressed as a range of estimated value of the vehicle. The low end of the range can be the wholesale value that is derived from the auction data from wholesales sales that occur at auto auctions and/or dealerships. A range can then be set above that value (such as 8 10%, depending on the dealer's preference), and the high end of the range is calculated.

Thus, a vehicle whose wholesale value at the auction or automobile dealership is $16,000 might have an estimated value of “16,000 to $17,600”. This range serves the dealer by expressing the true wholesale value, and serves the consumer by stretching the value closer to what they desire from their trade. In practice, if a dealer is keeping the vehicle for his retail lot, he is more apt to make the offer closer to high end of the range. The vehicle, in this case, will probably be about $19,800 at the retail sale. There is still plenty of profit and the dealer makes two customers (the original seller and the subsequent buyer of the used vehicle) very happy. An example of how this pricing page is broken down is illustrated in FIG. 5(i).

FIGS. 6(a)-(d) are exemplary computer screen shots of an embodiment of a credit score survey in accordance with the system of the invention. Once the Lead Generation System 7 activates the one or more credit score estimator graphical user interfaces, the consumer may interact with the credit score estimator feature to input data and receive an estimated credit score. As illustrated in FIGS. 6(a)-(d), the Lead Generation System 7 may output (e.g., display) a credit score survey that includes one or more questions associated with obtaining information about a consumer's credit history. These questions may not request highly confidential information associated with the consumer (e.g., social security number). In addition, filling out the credit score survey may not result a credit inquiry.

In one embodiment, the credit score survey may ask the consumer to answer the following questions: 1. Add up the total of all your credit card limits; 2. Add up the total of all you currently owe in credit card debt; 3. The amount of credit card debt that you owe as a percentage of your total credit card debt limits is; 4. How long have you had your oldest auto loan or credit account; 5. How many credit applications have you submitted in the last six months; 6. What is your current monthly auto payment amount; 7. How much do you expect your next auto payment will likely be; 8. Indicate the approximate amount you still owe on your vehicle; 9. Indicate the number of loan accounts (open or closed) that you have in each category: Auto Loans, Mortgages, Credit Cards; and 10. When is the last time you have had any of the following: a loan debt write off, a settlement, a foreclosure or bankruptcy, being 90 days past due on a loan or credit card payment.

It should be noted that the questions provided in the credit score survey may be modified based on the item or service of interest to be purchased or design preferences. For example, a credit score survey configured to estimate a consumer's credit score for the purchase of real estate property may ask questions directed to obtaining information related to the consumer's likelihood of repaying a mortgage loan. For example, a question in a credit score survey configured to estimate a consumer's credit score for the purchase of real estate property may include “What is your current mortgage payment” In another example, a question in a credit score survey configured to estimate a consumer's credit score for the purchase of real estate property may include “How much do you expect your next mortgage payment will be.” In yet another example, a question in a credit score survey configured to estimate a consumer's credit score for the purchase of real estate property may include “Indicate the approximate amount you still owe on your current home.” In addition, it should be noted that any number of questions (e.g., ten questions, nine questions, fifteen questions) may be provided in the credit score survey.

It should also be noted that the arrangement of the questions provided in the credit score survey may be changed based on design preferences. For example, the question “Add up the total of all your credit card limits” may appear at the end of the credit score survey.

In response to the question “Add up the total of all your credit card limits,” the credit score estimator graphical user interfaces may enable the consumer to provide at least one of the following answers: Over $20,000; $10,001-$20,000; $5,001-$10,000; $2,501-$5,000; $1,000-$2,500; $500; and $0. In response to the question “Add up the total of all you currently owe in credit card debt,” the credit score estimator graphical user interfaces may enable the consumer to provide at least one of the following answers: $30,000 or more; $18,000 to $30,000; $10,000 to $18,000; $2,501 to $10,000; and Under $2,500. In response to the question “The amount of credit card debt that you owe as a percentage of your total credit card debt limits is,” the credit score estimator graphical user interfaces may enable the consumer to provide at least one of the following answers: Over 80%; 71%-80%; 61%-70%; 51%-60%; 41%-50%; 21%-40%; and 0%-20%. In response to the question “How long have you had your oldest auto loan or credit account,” the credit score estimator graphical user interfaces may enable the consumer to provide at least one of the following answers: 1 year; 2-3 years; 4-5 years; 6 years; 7 years; 8 years; 9 years; and 10+ years. In response to the question “How many credit applications have you submitted in the last six months,” the credit score estimator graphical user interfaces may enable the consumer to provide at least one of the following answers: 0-1; 2; 3; 4; and 5 or more. In response to the question “What is your current monthly auto payment amount,” the credit score estimator graphical user interfaces may enable the consumer to provide at least one of the following answers: $250 or less; $251-$350; $350-$500; 500-$700; and Over $700. In response to the question “How much do you expect your next auto payment will likely be,” the credit score estimator graphical user interfaces may enable the consumer to provide at least one of the following answers: $250 or less; $251-$350; $350-$500; $500-$700; and Over $700. In response to the question “Indicate the approximate amount you still owe on your vehicle,” the credit score estimator graphical user interfaces may enable the consumer to provide at least one of the following answers: Don't Know; $0; Less than $1,000; $1,000-$3,000; $4,000-$5,000; $5,000-$6,000; and $6,000 or more. In response to the question “Indicate the number of loan accounts (open or closed) that you have in each category: Auto Loans, Mortgages, Credit Cards,” the credit score estimator graphical user interfaces may enable the consumer to provide at least one of the following answers: 0; 1; 2; 2-3; 3; 4; 4+; 4-6; 5+; and 7+. In response to the question “When is the last time you have had any of the following: a loan debt write off, a settlement, a foreclosure or bankruptcy, being 90 days past due on a loan or credit card payment,” the credit score estimator graphical user interfaces may enable the consumer to provide at least one of the following answers: Never; 6 months ago; 12 months ago; 2 years ago; 3 years ago; 4 years ago; 5-7 years ago; and over 7 years ago.

Based on the answers received from the consumer, the Lead Generation System 7 may determine (e.g., calculate) an estimate of the consumer's credit score using one or more scoring algorithms. In one embodiment, the one or more scoring algorithms may determine an estimate of the consumer's credit score without accessing a credit report associated with the consumer from any credit reporting agency (e.g., the Experian credit reporting agency, the Equifax credit reporting agency, the Transunion credit reporting agency). In another embodiment, the one or more scoring algorithms may determine an estimate of the consumer's credit score for free (e.g., without requesting the consumer to pay a fee).

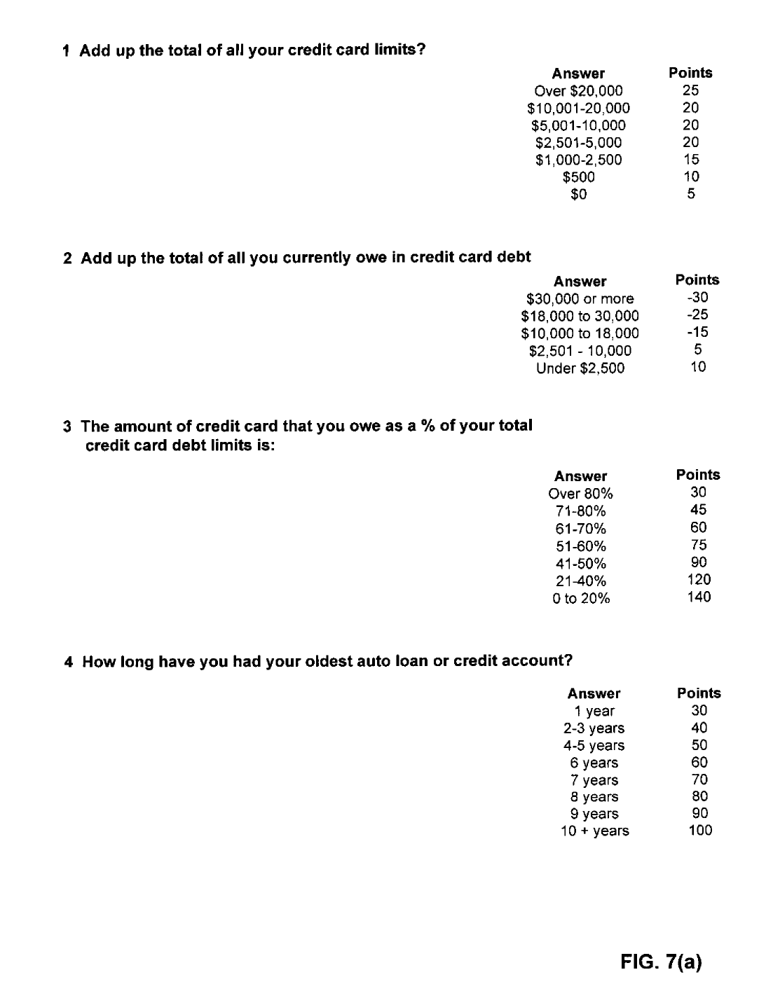

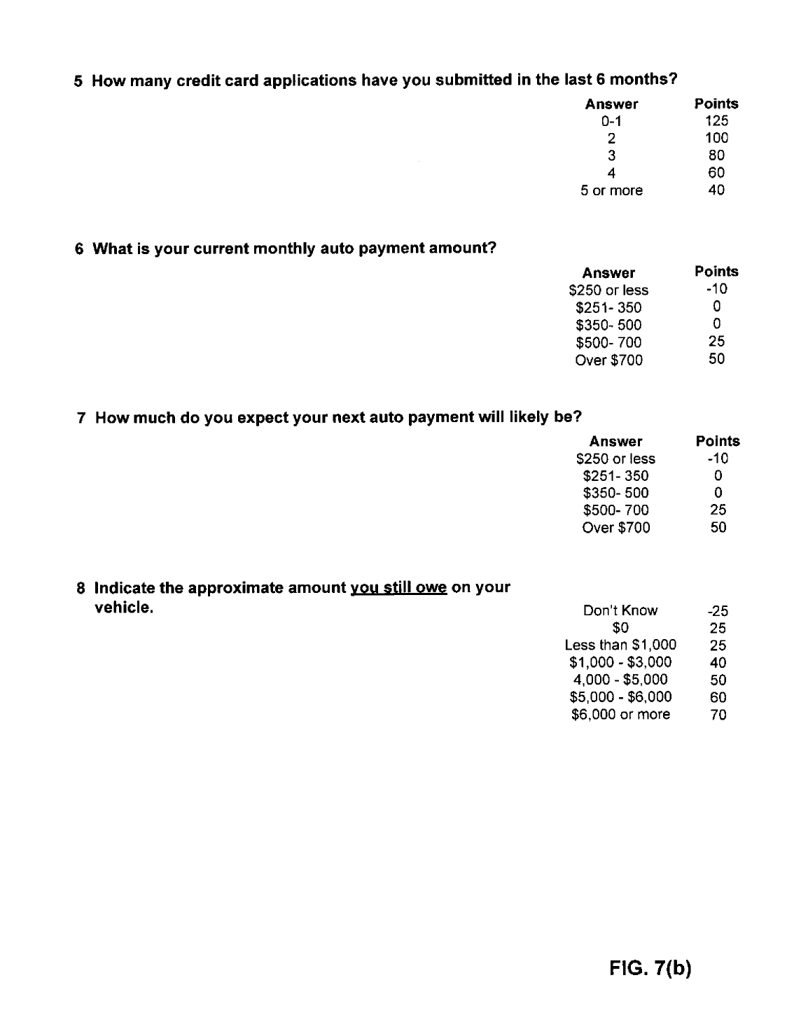

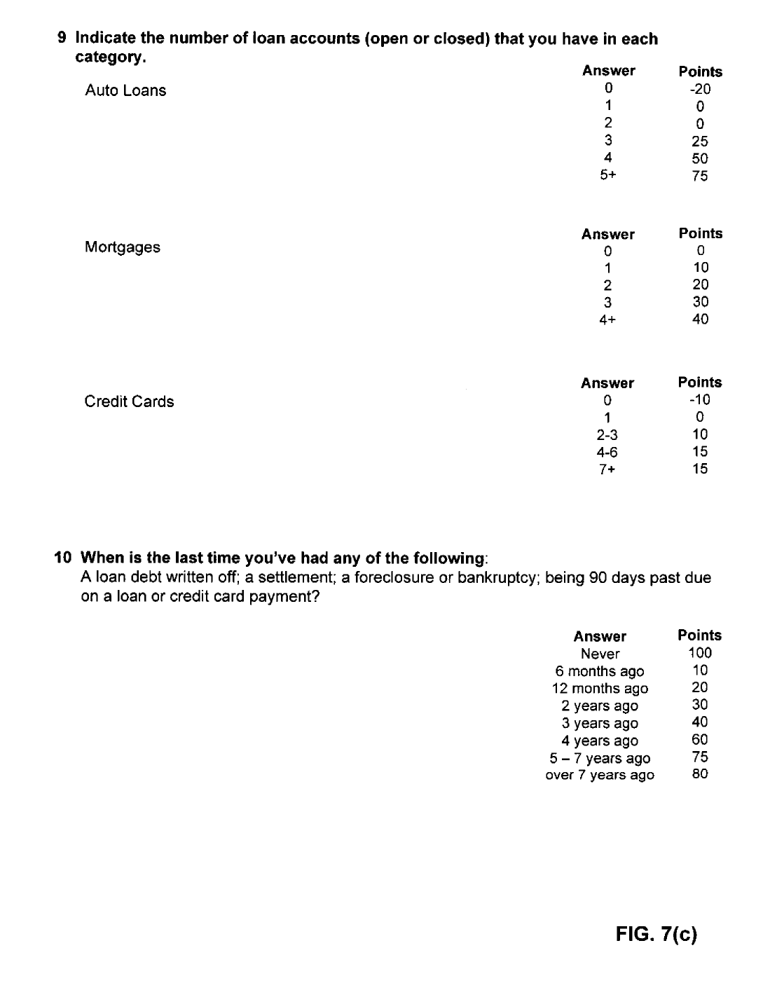

FIGS. 7(a)-(c) are exemplary charts of an embodiment of a scoring algorithm in accordance with the system of the invention. As illustrated in FIGS. 7(a)-(c), a scoring algorithm may estimate the consumer's credit score by applying a point system to the consumer's answers to the questions provided in the credit score survey. Accordingly, for each of the consumer's answers to the credit score survey, the Lead Generation System 7 may assign a point value. In some embodiments, points may be any, or a combination, of positive points, negative points, and neutral points. In one embodiment, the consumer's estimated credit score may include the total number of points assigned from the point system. In another embodiment, the consumer's estimated credit score may include a number derived from the total number of points assigned from the point system. In another embodiment, the consumer's estimated credit score may include an estimated credit score range (e.g., an estimated credit score range of 40, an estimated credit score range of 50).

For example, a consumer may have answered the question “Add up the total of all your credit card limits” with “$10,001-20,000.” Based on the consumer's answer, the Lead Generation System 7 may assign twenty (20) points to the consumer's estimated credit score. In the same example, the consumer may have answered the question “How long have you had your oldest auto loan or credit account” with “10+ years.” Based on the consumer's answer, the Lead Generation System 7 may assign one-hundred (100) points to the consumer's estimated credit score. Accordingly, the consumer's estimate credit score may be one-hundred and twenty (120) as a result of the consumer's answers to these two questions. The Lead Generation System 7 may continue to assign points to the consumer's estimated credit score for the answers to the remaining questions.

It should be noted that the point values assigned to each answer may be modified based on design preferences. For example, the a consumer may have answered the question “Add up the total of all your credit card limits” with “$10,001-20,000.” Based on the consumer's answer, the Lead Generation System 7 may assign thirty (30) points to the consumer's estimated credit score. The point values assigned to each answer may include any point values such that the estimated credit score is determined to be equal to or lower than a perfect credit score (e.g., 850 credit score).

At the end of the credit score survey, the consumer may be requested to input contact information as illustrated in FIG. 6(d). Contact information may include any, or a combination, of a consumer's first name, a consumer's last name, a consumer's e-mail address, a consumer's street address, and a consumer's phone number. The Lead Generation System 7 may determine the consumer's estimated credit score based on the answers to the credit score survey and may output (e.g., display) the consumer's estimated credit score to the consumer at a consumer system (e.g., the seller access systems illustrated in FIG. 1) and via an email (e.g., a confirmation email) to the consumer. In one embodiment, the Lead Generation System 7 may provide the consumer with one or more estimated financing rates based on the consumer's estimated credit score. In such embodiments, the estimated financing rates may be provided as a range of rates (e.g., a one (1) percentage point range).

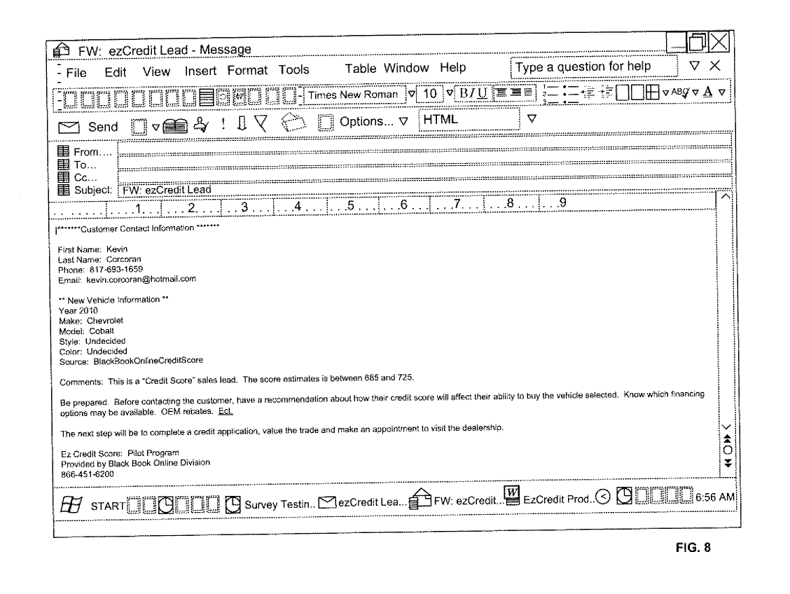

FIG. 8 is an exemplary computer screen shot of an email-based sales lead in accordance with the system of the invention. The Lead Generation System 7 may create and transmit a sales lead to a system associated with the dealership's website (e.g., the buyer access systems illustrated in FIG. 1) in the form of an email based on the consumer's estimated credit score and contact information. The sales lead may not include the consumer's answers to the credit score survey. In addition, the sales lead may include vehicle interest information that indicates the vehicle that the consumer is interested in purchasing. In one embodiment, vehicle interest information may include any, or a combination, of year information, make information, model information, style information, and color information. An employee of the dealership (e.g., sales man, financing representative, internet manager, sales manager) may contact the consumer using the information provided in the sales lead and arrange an appointment to for the consumer to visit the dealership.

The buyer access systems illustrated in FIG. 1 may include a Customer Relationship Management (CRM) system associated with a dealership. The Lead Generation System 7 may create and transmit the sales lead in a format that is executable by the CRM system. The Lead Generation System 7 may enable dealerships to set unique thresholds that indicate when a sales lead should be transmitted to the dealership's CRM system. For example, a first threshold may indicate that the Lead Generation System 7 transmit sales leads for consumer's with an estimated credit score over 630. In another example, a second threshold may indicate that the Lead Generation System 7 transmit sales leads for consumer's with an estimated credit score of 650 or more.

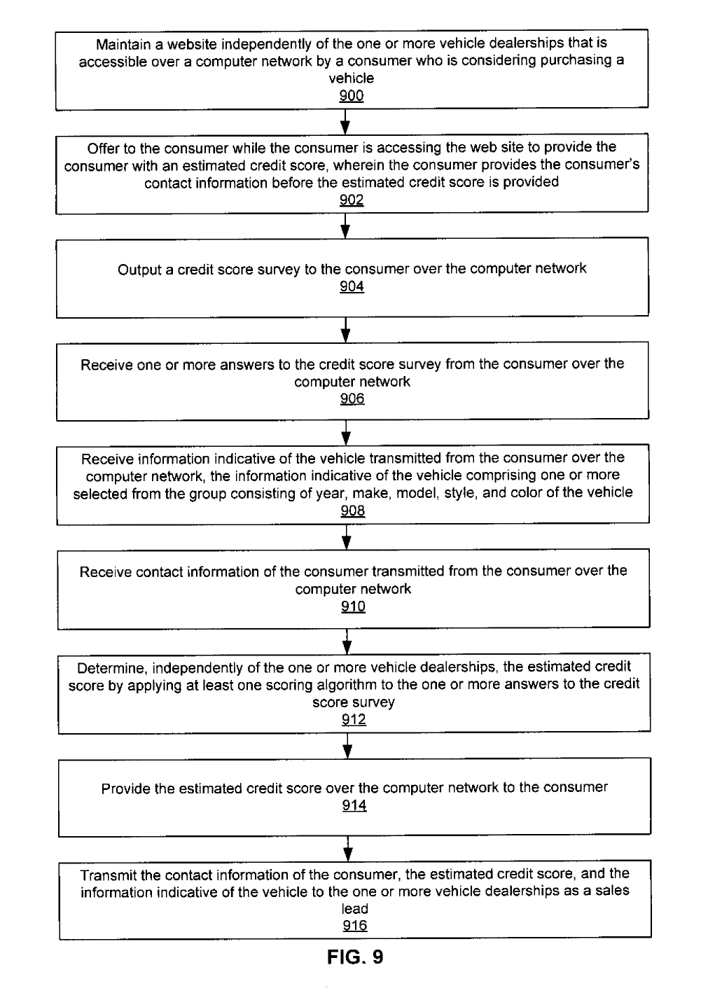

FIG. 9 is a flowchart for a method of generating a lead in accordance with the system of the invention. This exemplary method is provided by way of example, as there are a variety of ways to carry out methods disclosed herein. The method shown in FIG. 9 may be executed or otherwise performed by one or a combination of various systems. The method is described below as carried out by the Lead Generation System 7 shown in FIG. 1 by way of example. Each block shown in FIG. 9 represents one or more processes, methods, or subroutines carried out in the exemplary method. Referring to FIG. 9, the exemplary method may begin at block 900.

In block 900, the method may include maintaining a web site independently of the one or more vehicle dealerships that is accessible over a computer network by a consumer who is considering purchasing a vehicle. In one embodiment, the Lead Generation System 7 may maintain a web site independently of the one or more vehicle dealerships that is accessible over a computer network by a consumer who is considering purchasing a vehicle. The method may continue to block 902.

In block 902, the method may include offering to the consumer while the consumer is accessing the web site to provide the consumer with an estimated credit score, wherein the consumer provides the consumer's contact information before the estimated eredit score is provided. In one embodiment, the Lead Generation System 7 may offer to the consumer while the consumer is accessing the web site to provide the consumer with an estimated credit score, wherein the consumer provides the consumer's contact information before the estimated credit score is provided. The method may continue to block 904.

In block 904, the method may include outputting a credit score survey to the consumer over the computer network. In one embodiment, the Lead Generation System 7 may output a credit score survey to the consumer over the computer network. The method may continue to block 906.

In block 906, the method may include receiving one or more answers to the credit score survey from the consumer over the computer network. In one embodiment, the Lead Generation System 7 may receive one or more answers to the credit score survey from the consumer over the computer network. The method may continue to block 908.

In block 908, the method may include receiving information indicative of the vehicle transmitted from the consumer over the computer network, the information indicative of the vehicle comprising one or more selected from the group consisting of year, make, model, style, and color of the vehicle. In one embodiment, the Lead Generation System 7 may receive information indicative of the vehicle transmitted from the consumer over the computer network, the information indicative of the vehicle comprising one or more selected from the group consisting of year, make, model, style, and color of the vehicle. The method may continue to block 910.

In block 910, the method may include receiving contact information of the consumer transmitted from the consumer over the computer network. In one embodiment, the Lead Generation System 7 may receive contact information of the consumer transmitted from the consumer over the computer network. The method may continue to block 912.

In block 912, the method may include determining, independently of the one or more vehicle dealerships, the estimated credit score by applying at least one scoring algorithm to the one or more answers to the credit score survey. In one embodiment, the Lead Generation System 7 may determine, independently of the one or more vehicle dealerships, the estimated credit score by applying at least one scoring algorithm to the one or more answers to the credit score survey. The method may continue to block 914.

In block 914, the method may include providing the estimated credit score over the computer network to the consumer. In one embodiment, the Lead Generation System 7 may provide the estimated credit score over the computer network to the consumer. The method may continue to block 916.

In block 916, the method may include transmitting the contact information of the consumer, the estimated credit score, and the information indicative of the vehicle to the one or more vehicle dealerships as a sales lead. In one embodiment, the Lead Generation System 7 may transmit the contact information of the consumer, the estimated credit score, and the information indicative of the vehicle to the one or more vehicle dealerships as a sales lead. The method may then end at block 916.

Although this invention has been described with reference to particular embodiments, it will be appreciated that many variations may be resorted to without departing from the spirit and scope of this invention. For example, while the present invention has been described in connection with lead generation from the valuation of automobiles, it is not limited thereto and may include any vehicle that is capable of being valued using historical sales data and specific vehicle history, such as motorcycles, mobile homes, recreational vehicles, boats and personal watercraft. Also the system of the present invention may be implemented over a local network or virtual private network or any internet worked system, and is not limited to the Internet.

In the preceding specification, various embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

What is claimed is:

1. A method of generating sales leads as a service for one or more vehicle dealerships that are not otherwise affiliated with the service, the method comprising:
maintaining a web site independently of the one or more vehicle dealerships that is accessible over a computer network by a consumer who is considering purchasing a vehicle;
offering to the consumer while the consumer is accessing the web site to provide the consumer with an estimated credit score, wherein the consumer provides the consumer's contact information before the estimated credit score is provided;
outputting a credit score survey to the consumer over the computer network;
receiving one or more answers to the credit score survey from the consumer over the computer network;
receiving information indicative of the vehicle transmitted from the consumer over the computer network, the information indicative of the vehicle comprising one or more selected from the group consisting of year, make, model, style, and color of the vehicle;
receiving contact information of the consumer transmitted from the consumer over the computer network;
determining, independently of the one or more vehicle dealerships, the estimated credit score by applying at least one scoring algorithm to the one or more answers to the credit score survey;
providing the estimated credit score over the computer network to the consumer; and
transmitting the contact information of the consumer, the estimated credit score, and the information indicative of the vehicle to the one or more vehicle dealerships as a sales lead.

2. The method of claim 1, wherein applying the scoring algorithm comprises applying a point system to the one or more answers to the credit score survey.

3. The method of claim 1, wherein the estimated credit score is determined as an estimated credit score range.

4. The method of claim 5, wherein the credit score range comprises a forty (40) point credit score range.

5. The method of claim 1, wherein the credit score survey comprises no more than fifteen (15) questions.

6. The method of claim 5, wherein the questions of the credit score survey comprise: 1. Add up the total of all your credit card limits; 2. Add up the total of all you currently owe in credit card debt; 3. The amount of credit card debt that you owe as a percentage of your total credit card debt limits is; 4. How long have you had your oldest auto loan or credit account; 5. How many credit applications have you submitted in the last six months; 6. What is your current monthly auto payment amount; 7. How much do you expect your next auto payment will likely be; 8. Indicate the approximate amount you still owe on your vehicle; 9. Indicate the number of loan accounts (open or closed) that you have in each category: Auto Loans, Mortgages, Credit Cards; and 10. When is the last time you have had any of the following: a loan debt write off, a settlement, a foreclosure or bankruptcy, being 90 days past due on a loan or credit card payment.

7. The method of claim 1, wherein the consumer's contact information comprises one or more selected from the group consisting of first name, last name, street address, phone number, and email address.

8. The method of claim 1, wherein the vehicle comprises at least one of an automobile, a motorcycle, a mobile home, a recreational vehicle, a boat, and a personal watercraft.

9. A system of generating sales leads as a service for one or more vehicle dealerships that are not otherwise affiliated with the service, the system comprising:
a computing apparatus configured to maintain a web site independently of the one or more vehicle dealerships that is accessible over a computer network by a consumer who may be considering potentially purchasing a vehicle;
a computing apparatus configured to offer to the consumer while the consumer is accessing the web site to provide the consumer with an estimated credit score, wherein the consumer provides the consumer's contact information before the estimated credit score is provided;
a computing apparatus configured to output a credit score survey to the consumer over the computer network;
a computing apparatus configured to receive one or more answers to the credit score survey from the consumer over the computer network;
a computing apparatus configured to receive information indicative of the vehicle transmitted from the consumer over the computer network, the information indicative of the vehicle comprising one or more selected from the group consisting of year, make, model, style, and color of the vehicle;
a computing apparatus configured to receive contact information of the consumer transmitted from the consumer over the computer network;
a computing apparatus configured to determine, independently of the one or more vehicle dealerships, the estimated credit score by applying at least one scoring algorithm to the one or more answers to the credit score survey;
a computing apparatus configured to provide the estimated credit score over the computer network to the consumer; and
a computing apparatus configured to transmit the contact information of the consumer, the estimated credit score, and the information indicative of the vehicle to the one or more vehicle dealerships as a sales lead.

10. The system of claim 9, wherein applying the scoring algorithm comprises applying a point system to the one or more answers to the credit score survey.

11. The system of claim 9, wherein the estimated credit score is determined as an estimated credit score range.

12. The system of claim 11, wherein the credit score range comprises a forty (40) point credit score range.

13. The system of claim 9, wherein the credit score survey comprises no more than fifteen (15) questions.

14. The system of claim 13, wherein the questions of the credit score survey comprise: 1. Add up the total of all your credit card limits; 2. Add up the total of all you currently owe in credit card debt; 3. The amount of credit card debt that you owe as a percentage of your total credit card debt limits is; 4. How long have you had your oldest auto loan or credit account; 5. How many credit applications have you submitted in the last six months; 6. What is your current monthly auto payment amount; 7. How much do you expect your next auto payment will likely be; 8. Indicate the approximate amount you still owe on your vehicle; 9. Indicate the number of loan accounts (open or closed) that you have in each category: Auto Loans, Mortgages, Credit Cards; and 10. When is the last time you have had any of the following: a loan debt write off, a settlement, a foreclosure or bankruptcy, being 90 days past due on a loan or credit card payment.

15. The system of claim 9, wherein the consumer's contact information comprises one or more selected from the group consisting of first name, last name, street address, phone number, and email address.

16. The system of claim 9, wherein the vehicle comprises at least one of an automobile, a motorcycle, a mobile home, a recreational vehicle, a boat, and a personal watercraft.

17. A method of generating sales leads as a service for one or more real estate companies that are not otherwise affiliated with the service, the method comprising:
maintaining a web site independently of the one or more real estate companies that is accessible over a computer network by a consumer who is considering purchasing real estate property;
offering to the consumer while the consumer is accessing the web site to provide the consumer with an estimated credit score, wherein the consumer provides the consumer's contact information before the estimated credit score is provided;
outputting a credit score survey to the consumer over the computer network;
receiving one or more answers to the credit score survey from the consumer over the computer network;
receiving information indicative of the real estate property transmitted from the consumer over the computer network, the information indicative of the real estate property comprising one or more selected from the group consisting of address, price, and type of the real estate property;
receiving contact information of the consumer transmitted from the consumer over the computer network;
determining, independently of the one or more real estate companies, the estimated credit score by applying at least one scoring algorithm to the one or more answers to the credit score survey;
providing the estimated credit score over the computer network to the consumer; and
transmitting the contact information of the consumer, the estimated credit score, and the information indicative of the real estate property to the one or more real estate companies as a sales lead.
